(19) United States
(12) Patent Application Publication
(10) Pub. No.: US 2026/0147243 A1
(43) Pub. Date: May 28, 2026

(54) STRETCHABLE ELECTRONIC DEVICE

(71) Applicant: InnoLux Corporation, Miao-Li County (TW)

(72) Inventors: Yuan-Lin WU, Miao-Li County (TW); Yu-Chia HUANG, Miao-Li County (TW); Tsung-Han TSAI, Miao-Li County (TW); Kuan-Feng LEE, Miao-Li County (TW); Ting-Wei LIANG, Miao-Li County (TW); Jiunn-Shyong LIN, Miao-Li County (TW); Chiu-Lien YANG, Miao-Li County (TW)

(73) Assignee: InnoLux Corporation, Miao-Li County (TW)

(21) Appl. No.: 19/326,747

(22) Filed: Sep. 12, 2025

(30) Foreign Application Priority Data
Nov. 25, 2024 (CN) 202411687386.8

(51) Int. Cl. G02F 1/1339; G02F 1/1333; G02F 1/1335; G02F 1/1341; G02F 1/1343

(52) U.S. Cl. CPC G02F 1/1339; G02F 1/133368; G02F 1/133553; G02F 1/1341; G02F 1/134309

(57) ABSTRACT

A stretchable electronic device includes a first reflective panel. The first reflective panel includes a first substrate having at least one first opening, a second substrate opposite to the first substrate, a first liquid crystal layer disposed between the first substrate and the second substrate, a first frame glue disposed between the first substrate and the second substrate and adjacent to the first liquid crystal layer, and a first material layer disposed in the at least one first opening. A material of the first material layer is different from a material of the first substrate.

### BACKGROUND OF THE DISCLOSURE

### 1. Field of the Disclosure

The present disclosure relates to a stretchable electronic device, and more particularly to a stretchable display device.

### 2. Description of the Prior Art

Current reflective displays are difficult to be stretched, making it difficult to attach the reflective displays to curved surfaces, thereby limiting the application of the displays. Therefore, to improve the above-mentioned problems is still an important issue in the present field.

### SUMMARY OF THE DISCLOSURE

The present disclosure aims at providing a stretchable display device.

In some embodiments, a stretchable electronic device is provided by the present disclosure. The stretchable electronic device includes a first reflective panel. The first reflective panel includes a first substrate having at least one first opening, a second substrate opposite to the first substrate, a first liquid crystal layer disposed between the first substrate and the second substrate, a first frame glue disposed between the first substrate and the second substrate and adjacent to the first liquid crystal layer, and a first material layer disposed in the at least one first opening. A material of the first material layer is different from a material of the first substrate.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a top view of an electronic device according to a first embodiment of the present disclosure.

FIG. 2 schematically illustrates a cross-sectional view of the electronic device according to the first embodiment of the present disclosure.

FIG. 3 schematically illustrates a top view of an electronic device according to a second embodiment of the present disclosure.

FIG. 4 schematically illustrates a cross-sectional view of the electronic device according to the second embodiment of the present disclosure.

FIG. 5 schematically illustrates a top view of an electronic device according to a third embodiment of the present disclosure.

FIG. 6 schematically illustrates a cross-sectional view of the electronic device according to the third embodiment of the present disclosure.

FIG. 7 schematically illustrates a top view of an electronic device according to a fourth embodiment of the present disclosure.

FIG. 8 schematically illustrates a cross-sectional view of an electronic device according to a fifth embodiment of the present disclosure.

FIG. 9 schematically illustrates a cross-sectional view of an electronic device according to a sixth embodiment of the present disclosure.

FIG. 10 schematically illustrates a cross-sectional view of an electronic device according to a seventh embodiment of the present disclosure.

FIG. 11 schematically illustrates a cross-sectional view of an electronic device according to an eighth embodiment of the present disclosure.

FIG. 12 schematically illustrates a top view of an electronic device according to a ninth embodiment of the present disclosure.

FIG. 13 schematically illustrates a cross-sectional view of the electronic device according to the ninth embodiment of the present disclosure.

FIG. 14 schematically illustrates a cross-sectional view of an electronic device according to a tenth embodiment of the present disclosure.

FIG. 15 schematically illustrates a cross-sectional view of an electronic device according to an eleventh embodiment of the present disclosure.

FIG. 16 schematically illustrates a cross-sectional view of an electronic device according to a variant embodiment of the eleventh embodiment of the present disclosure.

FIG. 17 schematically illustrates a cross-sectional view of an electronic device according to a twelfth embodiment of the present disclosure.

FIG. 18 schematically illustrates a top view of an electronic device according to a thirteenth embodiment of the present disclosure.

FIG. 19 schematically illustrates a cross-sectional view of an electronic device according to a fourteenth embodiment of the present disclosure.

FIG. 20 schematically illustrates a cross-sectional view of an electronic device according to a fifteenth embodiment of the present disclosure.

FIG. 21 schematically illustrates a cross-sectional view of an electronic device according to a variant embodiment of the fifteenth embodiment of the present disclosure.

FIG. 22 and FIG. 23 schematically illustrate a manufacturing process of a reflective panel according to an embodiment of the present disclosure.

FIG. 24 schematically illustrates a manufacturing process of an electronic device according to an embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the device, and certain elements in various drawings may not be drawn to scale. In addition, the number and dimension of each element shown in drawings are only illustrative and are not intended to limit the scope of the present disclosure.

Certain terms are used throughout the description and following claims to refer to particular elements. As one skilled in the art will understand, electronic equipment manufacturers may refer to an element by different names. This document does not intend to distinguish between elements that differ in name but not function.

In the following description and in the claims, the terms “include”, “comprise” and “have” are used in an open-ended fashion, and thus should be interpreted to mean “include, but not limited to . . . ”.

It will be understood that when an element or layer is referred to as being “disposed on” or “connected to” another element or layer, it can be directly on or directly connected to the other element or layer, or intervening elements or layers may be presented (indirectly). In contrast, when an element is referred to as being “directly on” or “directly connected to” another element or layer, there are no intervening elements or layers presented. When an element or a layer is referred to as being “electrically connected” to another element or layer, it can be a direct electrical connection or an indirect electrical connection. The electrical connection or coupling described in the present disclosure may refer to a direct connection or an indirect connection. In the case of a direct connection, the ends of the elements on two circuits are directly connected or connected to each other by a conductor segment. In the case of an indirect connection, switches, diodes, capacitors, inductors, resistors, other suitable elements or combinations of the above elements may be included between the ends of the elements on two circuits, but not limited thereto.

Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

According to the present disclosure, the thickness, length and width may be measured through optical microscope, and the thickness or width may be measured through the cross-sectional view in the electron microscope, but not limited thereto.

In addition, any two values or directions used for comparison may have certain errors. In addition, the terms “equal to”, “equal”, “the same”, “approximately” or “substantially” are generally interpreted as being within ±20%, ±10%, ±5%, ±3%, ±2%, ±1%, or ±0.5% of the given value.

In addition, the terms “the given range is from a first value to a second value” or “the given range is located between a first value and a second value” represents that the given range includes the first value, the second value and other values there between.

If a first direction is said to be perpendicular to a second direction, the included angle between the first direction and the second direction may be located between 80 to 100 degrees. If a first direction is said to be parallel to a second direction, the included angle between the first direction and the second direction may be located between 0 to 10 degrees.

Unless it is additionally defined, all terms (including technical and scientific terms) used herein have the same meaning as commonly understood by those ordinary skilled in the art. It can be understood that these terms that are defined in commonly used dictionaries should be interpreted as having meanings consistent with the relevant art and the background or content of the present disclosure, and should not be interpreted in an idealized or overly formal manner, unless it is specifically defined in the embodiments of the present disclosure.

It should be noted that the technical features in different embodiments described in the following can be replaced, recombined, or mixed with one another to constitute another embodiment without departing from the spirit of the present disclosure.

The electronic device of the present disclosure may include a display device, a sensing device, a back-light device, an antenna device, a tiled device or other suitable electronic devices, but not limited thereto. The electronic device of the present disclosure may include any suitable device applied to the above-mentioned devices. The electronic device may be a foldable electronic device, a flexible electronic device or a stretchable electronic device. The display device may for example be applied to laptops, common displays, tiled displays, vehicle displays, touch displays, televisions, monitors, smart phones, tablets, light source modules, lighting devices or electronic devices applied to the products mentioned above, but not limited thereto. The sensing device may include a biosensor, a touch sensor, a fingerprint sensor, other suitable sensors or combinations of the above-mentioned sensors. The antenna device may for example include a liquid crystal antenna device or a non-liquid crystal antenna device, but not limited thereto. The tiled device may for example include a tiled display device or a tiled antenna device, but not limited thereto. The outline of the electronic device may be a rectangle, a circle, a polygon, a shape with curved edge or other suitable shapes. The electronic device may include electronic units, wherein the electronic units may include passive elements or active elements, such as capacitor, resistor, inductor, diode, transistor, sensors, and the like. The diode may include a light emitting diode or a photo diode. The light emitting diode may for example include an organic light emitting diode (OLED) or an inorganic light emitting diode. The inorganic light emitting diode may for example include a mini light emitting diode (mini LED), a micro light emitting diode (micro LED) or a quantum dot light emitting diode (QLED), but not limited thereto. It should be noted that the electronic device of the present disclosure may be combinations of the above-mentioned devices, but not limited thereto. The electronic device may include peripheral systems such as driving systems, controlling systems, light source systems to support display devices, antenna devices, wearable devices (such as augmented reality devices or virtual reality devices), vehicle devices (such as windshield of car) or tiled devices.

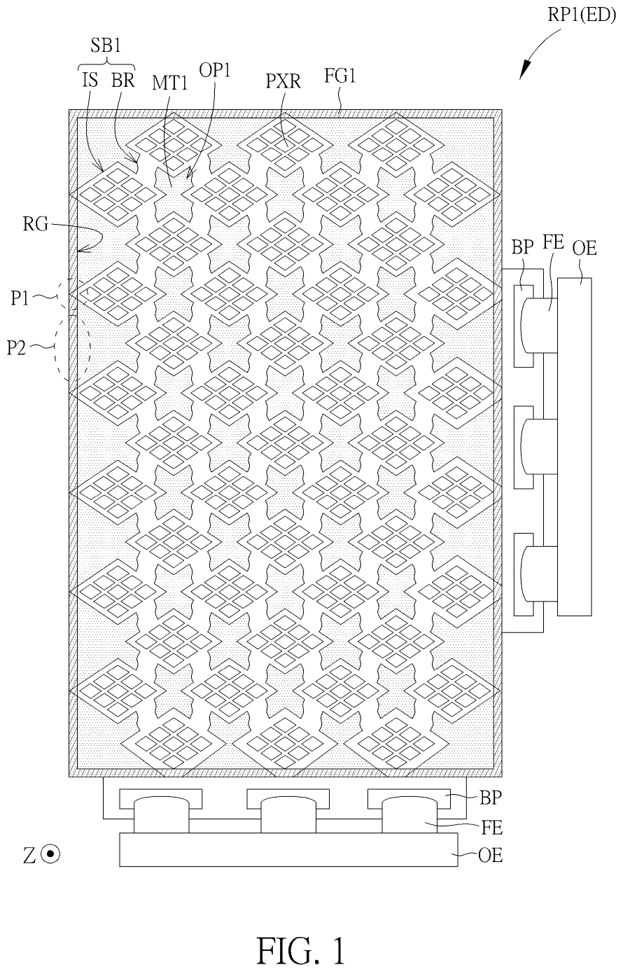

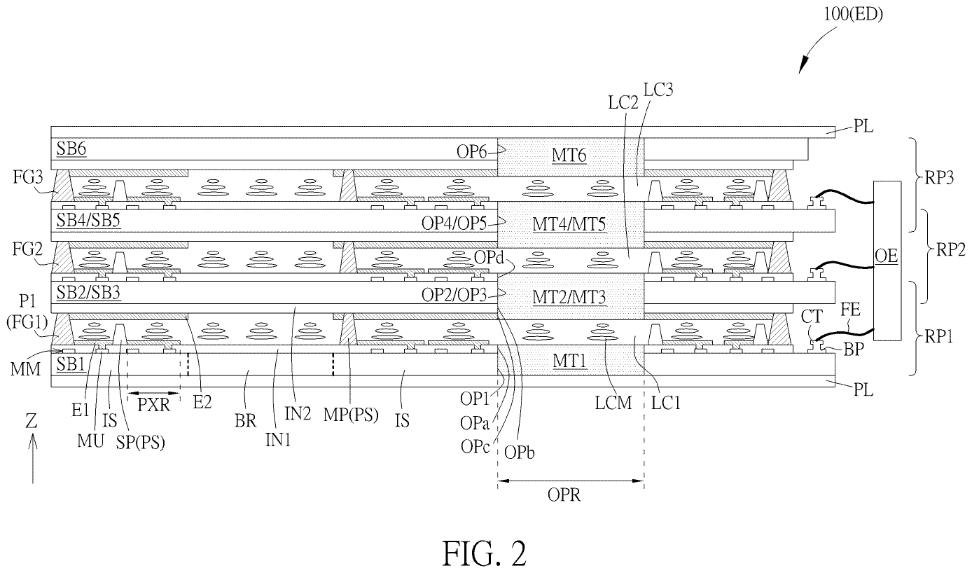

Referring to FIG. 1 and FIG. 2, FIG. 1 schematically illustrates a top view of an electronic device according to a first embodiment of the present disclosure, and FIG. 2 schematically illustrates a cross-sectional view of the electronic device according to the first embodiment of the present disclosure. The electronic device of the present disclosure may include a flexible electronic device, wherein the term “flexible” means that the electronic device may be curved, folded, rolled, stretched or deformed in other ways. The electronic device of the present embodiment may include a stretchable electronic device ED, wherein the stretchable electronic device ED may be stretched in any direction perpendicular to the normal direction (that is, the direction Z) of the stretchable electronic device ED and be deformed, but not limited thereto. The electronic device of the present disclosure may include a reflective display device. That is, the stretchable electronic device ED may include a stretchable display device 100, and the stretchable display device 100 may include a reflective display device. In the present embodiment, the stretchable display device 100 may include a cholesteric liquid crystal display device, but not limited thereto. In such condition, the stretchable display device 100 may include a cholesteric liquid crystal panel. In some embodiments, the stretchable electronic device ED may be combinations of the stretchable display device 100 and other electronic devices.

According to the present embodiment, the stretchable display device 100 may include at least one reflective panel, wherein the reflective panel includes a cholesteric liquid crystal panel or reflective panels of other suitable materials, but not limited thereto. In an embodiment, the stretchable display device 100 may include a reflective panel or a structure formed by stacking a plurality of reflective panels. As shown in FIG. 2, the stretchable electronic device ED may be formed by stacking a first reflective panel RP1, a second reflective panel RP2 and/or a third reflective panel RP3 in sequence. FIG. 1 just exemplary shows the top view of a reflective panel (such as the first reflective panel RP1) in the stretchable electronic device ED, and the top view structures of other reflective panels may refer to FIG. 1. The detailed structure of each reflective panel in the stretchable electronic device ED will be described in the following.

As shown in FIG. 2, the first reflective panel RP1 includes a first substrate SB1, a second substrate SB2, a first liquid crystal layer LC1, a plurality of first electrodes E1 and a plurality of second electrodes E2, but not limited thereto. The second substrate SB2 is opposite to the first substrate SB1. The first electrodes E1, the second electrodes E2 and the first liquid crystal layer LC1 are disposed between the first substrate SB1 and the second substrate SB2. It should be noted that FIG. 1 just shows some of the elements and layers of the first reflective panel RP1, and the structures of other layers and elements may refer to FIG. 2. In detail, the first reflective panel RP1 further includes an insulating layer IN1 and/or an insulating layer IN2 disposed between the first substrate SB1 and the second substrate SB2, wherein the insulating layer IN1 may be located between the first substrate SB1 and the first liquid crystal layer LC1 (or the first electrodes E1), and the insulating layer IN2 may be located between the second substrate SB2 and the first liquid crystal layer LC1 (or the second electrodes E2). The insulating layer IN1 may optionally contact the first substrate SB1, and the insulating layer IN2 may optionally contact the second substrate SB2, but not limited thereto. The first electrodes E1 may be disposed between the insulating layer IN1 and the first liquid crystal layer LC1. The second electrodes E2 may be disposed between the insulating layer IN2 and the first liquid crystal layer LC1. The insulating layer IN1 and the insulating layer IN2 may serve as buffer layers and may include any suitable insulating material, but not limited thereto. The first reflective panel RP1 may include a first frame glue FG1, wherein the first frame glue FG1 is disposed between the first substrate SB1 and the second substrate SB2 and adjacent to the first liquid crystal layer LC1. The first frame glue FG1 may be disposed between the insulating layer IN1 and the insulating layer IN2. The first frame glue FG1 may define the disposition range of the first liquid crystal layer LC1. As shown in FIG. 1, the first frame glue FG1 may enclose a region RG, and the first liquid crystal layer LC1 may be disposed in the region RG. The first frame glue FG1 may surround the first liquid crystal layer LC1. The first frame glue FG1 may be used to fix the first substrate SB1 and the second substrate SB2 to reduce leakage of the first liquid crystal layer LC1. The first frame glue FG1 may include any suitable glue material, such as a photo-curable adhesive or a thermosetting adhesive. The first liquid crystal layer LC1 may include a plurality of liquid crystal molecules LCM.

The first substrate SB1 may include a flexible substrate or may be at least partially a flexible substrate. The first substrate SB1 may include a stretchable substrate, but not limited thereto. The material of the flexible substrate may include polyimide (PI), polycarbonate (PC), polyethylene terephthalate (PET), other suitable materials or combinations of the above-mentioned materials. According to the present embodiment, the first substrate SB1 may be a patterned substrate. As shown in FIG. 1, the first substrate SB1 may include a plurality of island portions IS and a plurality of bridge portions BR, wherein at least one of the bridge portions BR may connect adjacent two of the island portions IS. As shown in FIG. 1, a bridge portion BR may be connected between two adjacent island portions IS of the first substrate SB1. The island portion IS may have a rectangular, diamond, circular, polygonal or irregular shape, and the bridge portion BR may have a strip shape, but not limited thereto. The bridge portion BR may be configured to change the distance between two adjacent island portions IS to which it connects. When the first reflective panel RP1 is deformed (such as being stretched), the bridge portion BR may be deformed, such that the size (for example, the length or the width) of the bridge portion BR may be changed, thereby changing the distance between two adjacent island portions IS. Or, through different patterning designs, bridge portions BR with different sizes may be designed, thereby changing the distance between two adjacent island portions IS. In some embodiments, as shown in FIG. 1 and FIG. 2, the island portions IS and the bridge portions BR may include the first substrate SB1. The pattern of the first substrate SB1 shown in FIG. 1 is exemplary, it is not limited in the present disclosure. The island portion IS and the bridge portion BR may include any suitable shape and arrangement way to form the first substrate SB1 with different patterns.

The first substrate SB1 may have at least one first opening OP1, wherein the first opening OP1 may be formed in the patterning process of the first substrate SB1. The first opening OP1 may penetrate or may not penetrate the first substrate SB1, it is not limited in the present disclosure. The first reflective panel RP1 may include an opening region OPR (as shown in FIG. 2), and the first opening OP1 may correspond to the opening region OPR. The opening region OPR may be defined as the region corresponding to or overlapping the first opening OP1. The opening region OPR may be other regions of the first reflective panel RP1 except the region corresponding to the first substrate SB1. Although the first substrate SB1 shown in FIG. 2 includes a single layer structure, the first substrate SB1 may include a multi-layer structure in some embodiments.

The first reflective panel RP1 may further include a first material layer MT1 disposed in at least one first opening OP1 of the first substrate SB1. In the present embodiment, the first material layer MT1 may be disposed corresponding to the opening region OPR. As shown in FIG. 2, the insulating layer IN1 may be disposed on the first substrate SB1. After that, a patterning process may be performed on the first substrate SB1 and the insulating layer IN1 to form the first opening OP1 of the first substrate SB1 and an opening OPa of the insulating layer IN1. The opening OPa of the insulating layer IN1 may overlap the first opening OP1 of the first substrate SB1. The first material layer MT1 may be disposed in at least one opening OPa of the insulating layer IN1, but not limited thereto. In some embodiments, the first material layer MT1 may fully fill the opening OPa and the first opening OP1, as shown in FIG. 2. In some embodiments, the first material layer MT1 may fully fill the first opening OP1, but the first material layer MT1 is not disposed in the opening OPa. In some embodiments, the first material layer MT1 may not fully fill the first opening OP1. The material of the first material layer MT1 may be different from the material of the first substrate SB1. The coefficient of elasticity of the first material layer MT1 may be greater than the coefficient of elasticity of the first substrate SB1. The first material layer MT1 may include any suitable organic insulating material, but not limited thereto. Through the disposition of the first material layer MT1, the flexibility of the first reflective panel RP1 may be improved.

As shown in FIG. 2, the second substrate SB2 may be patterned, but not limited thereto. The first substrate SB1 and the second substrate SB2 may have substantially the same pattern. In a top view direction of the first reflective panel RP1, the patterns of the first substrate SB1 and the second substrate SB2 may substantially overlap. The second substrate SB2 may be patterned and include a plurality of island portions IS and a plurality of bridge portions BR, and the second substrate SB2 may have at least one second opening OP2, wherein the island portions IS of the second substrate SB2 may respectively correspond to or overlap the island portions IS of the first substrate SB1, the bridge portions BR of the second substrate SB2 may respectively correspond to or overlap the bridge portions BR of the first substrate SB1, and the second opening OP2 of the second substrate SB2 may correspond to or overlap the first opening OP1 of the first substrate SB1. In addition, the first reflective panel RP1 may further include a second material layer MT2 disposed in at least one second opening OP2 of the second substrate SB2. Similarly, the insulating layer IN2 and the second substrate SB2 may be patterned simultaneously to form at least one opening OPb corresponding to the second opening OP2, and the second material layer MT2 may be disposed in at least one opening OPb of the insulating layer IN2, but not limited thereto. The coefficient of elasticity of the second material layer MT2 may be greater than the coefficient of elasticity of the second substrate SB2. The material of the second material layer MT2 may refer to the material of the first material layer MT1 mentioned above. Only one of the first substrate SB1 and the second substrate SB2 may be patterned. In some embodiments, the first substrate SB1 may be patterned, and the second substrate SB2 may not be patterned. In such condition, the first reflective panel RP1 may not include the second material layer MT2. In some embodiments, the second substrate SB2 may be patterned, and the first substrate SB1 may not be patterned. In such condition, the first reflective panel RP1 may not include the first material layer MT1. The material of the second substrate SB2 may refer to the material of the first substrate SB1 mentioned above, and will not be redundantly described.

According to the present embodiment, the first electrodes E1 and the second electrodes E2 may be disposed corresponding to the island portions IS of the substrate (such as the first substrate SB1 and/or the second substrate SB2), but not limited thereto. The first electrodes E1 and the second electrodes E2 may be disposed on the island portions IS of the first substrate SB1 and may correspond to or overlap the island portions IS of the second substrate SB2. One of the first electrode E1 and the second electrode E2 may serve as the pixel electrode, and the other one of the first electrode E1 and the second electrode E2 may serve as the common electrode. The first electrode E1 and the second electrode E2 may include any suitable conductive material, such as transparent conductive materials. The transparent conductive material for example includes indium tin oxide (ITO), indium zinc oxide (IZO) or indium gallium oxide (IGO), but not limited thereto. In the present embodiment, each of the island portions IS of the first substrate SB1 and/or the second substrate SB2 may correspond to at least one first electrode E1 and at least one second electrode E2, but not limited thereto. In some embodiments, the first electrode E1 and the second electrode E2 may not correspond to or not overlap some island portions IS. The first electrodes E1 and the second electrodes E2 may not correspond to or not overlap the opening region OPR. As shown in FIG. 2, the second electrode E2 may include an opening OPc corresponding to or overlapping the opening region OPR, wherein the opening OPc may correspond to or overlap the first opening OP1, the second opening OP2, the opening OPa and/or the opening OPb. In addition, the first electrodes E1 and the second electrodes E2 may be disposed not corresponding to or not overlapping the bridge portions BR of the first substrate SB1 and/or the second substrate SB2.

According to the present embodiment, the first liquid crystal layer LC1 may be completely (or entirely) disposed in the first reflective panel RP1. As shown in FIG. 1, the first frame glue FG1 may be substantially disposed along the outer edge of the first reflective panel RP1 and enclose a region RG, and the first liquid crystal layer LC1 may be disposed corresponding to the region RG. Therefore, the first frame glue FG1 may surround the first liquid crystal layer LC1 and be adjacent to the first liquid crystal layer LC1. In the top view direction (that is, the direction Z) of the stretchable electronic device ED, the first liquid crystal layer LC1 overlaps at least one first opening OP1. As shown in FIG. 1, the first frame glue FG1 may be disposed along the outer edge of the first substrate SB1 and/or the outer edge of the first material layer MT1, but not limited thereto. The first frame glue FG1 shown in FIG. 2 may be a portion (that is, the portion P1) of the first frame glue FG1 disposed on the first substrate SB1. In the present embodiment, the portion P1 of the first frame glue FG1 disposed on the first substrate SB1 may be located between the insulating layer IN1 and the insulating layer IN2 and may contact the insulating layer IN1 and the insulating layer IN2, but not limited thereto. The portion P1 of the first frame glue FG1 may be disposed corresponding to the island portion IS and/or the bridge portion BR of the first substrate SB1. Although it is not shown in the figure, the portion P2 of the first frame glue FG1 disposed on the first material layer MT1 may contact the first material layer MT1, but not limited thereto. The first liquid crystal layer LC1 may overlap the first substrate SB1 and the first material layer MT1. In other words, in the top view direction (that is, the direction Z) of the stretchable electronic device ED, the first liquid crystal layer LC1 may overlap the island portions IS and the bridge portions BR of the first substrate SB1 and the opening region OPR of the first reflective panel RP1. In the top view direction (that is, the direction Z) of the stretchable electronic device ED, the first liquid crystal layer LC1 may overlap the island portions IS, the bridge portions BR and the second opening OP2 of the second substrate SB2. In the present embodiments, the portion of the first liquid crystal layer LC1 corresponding to or overlapping the opening region OPR may be disposed between the first material layer MT1 and the second material layer MT2 and may optionally contact the first material layer MT1 and the second material layer MT2, but not limited thereto.

According to the present embodiment, the first reflective panel RP1 may have a plurality of pixel regions PXR, wherein the pixel regions PXR may be defined as the overlapping regions of the first electrodes E1 and the second electrodes E2. The first liquid crystal layer LC1 is disposed between the plurality of first electrodes E1 and the plurality of second electrodes E2. As shown in FIG. 2, a pixel region PXR may be the region corresponding to a first electrode E1 and a portion of the second electrode E2 overlapping the first electrode E1. The pixel regions PXR may correspond to the island portions IS. The pixel region PXR may not correspond to the bridge portions BR of the first substrate SB1 and/or the second substrate SB2 and the opening region OPR. That is, in the top view direction of the stretchable electronic device ED, at least one first opening OP1 may not overlap the pixel region PXR. In other words, in the first substrate SB1 and/or the second substrate SB2, the island portions IS may be configured to dispose the first electrodes E1 and the second electrodes E2 and may correspond to the plurality of pixel regions PXR, and the bridge portions BR may be used to provide stretching effect of the first substrate SB1 and/or the second substrate SB2. In the present embodiment, an island portion IS may correspond to at least one pixel region PXR, but not limited thereto. As shown in FIG. 1, an island portion IS may correspond to nine pixel regions PXR, but not limited thereto. The number of the pixel regions PXR corresponding to an island portion IS may be determined according to the demands of design of the first reflective panel RP1. In the top view direction of the first reflective panel RP1, the first frame glue FG1 may surround the pixel regions PXR of the first reflective panel RP1. The arrangement of the pixel regions PXR shown in FIG. 1 is exemplary, it is not limited in the present disclosure. The numbers and arrangements of the pixel regions PXR corresponding to different island portions IS may be different.

As shown in FIG. 2, the first liquid crystal layer LC1 disposed between the first electrodes E1 and the second electrodes E2 may correspond to the plurality of pixel regions PXR in the first reflective panel RP1. A portion of the first liquid crystal layer LC1 (for example, the portion of the first liquid crystal layer LC1 corresponding to the bridge portions BR and the opening region OPR) may not correspond to the pixel region PXR. The first reflective panel RP1 may further include a conductive layer MM disposed between the first substrate SB1 and the first electrodes E1. The conductive layer MM may be disposed on the first substrate SB1, and the insulating layer IN1 may be disposed on the conductive layer MM, but not limited thereto. The conductive layer MM may be electrically connected to the first electrodes E1 through the vias in the insulating layer IN1. The conductive layer MM may provide electrical signals to the first electrodes E1 to change the voltage difference between the first electrodes E1 and the second electrodes E2, thereby controlling the arrangement (or the state) of the liquid crystal molecules LCM of the first liquid crystal layer LC1 between the first electrodes E1 and the second electrodes E2. The conductive layer MM may include a plurality of conductive units MU (for example, including wires), and these conductive units MU may respectively be electrically connected to at least one of the first electrodes E1. The conductive layer MM (or the conductive units MU) may include any suitable conductive material, such as metal materials, but not limited thereto. The impedance of the conductive layer MM (or the conductive unit MU) may be lower than the impedance of the first electrode E1. The driving way of the first reflective panel RP1 of the present embodiment may be a passive driving, but not limited thereto. By driving the first reflective panel RP1 in a passive driving way, the space occupied by the driving unit may be reduced, thereby increasing the aperture ratio of the first reflective panel RP1. Although the conductive layer MM shown in FIG. 2 includes a single layer structure, the conductive layer MM may include a multi-layer structure in some embodiments. The conductive layer MM may for example include a multi-layer structure formed by stacking insulating layers and conductive layers, but not limited thereto.

According to the present embodiment, the first reflective panel RP1 may further include a plurality of spacers PS disposed between the first substrate SB1 and the second substrate SB2. The spacers PS may be disposed between the insulating layer IN1 and the insulating layer IN2. The spacers PS may include main spacers MP and sub spacers SP, and the thickness of the main spacer MP may be greater than the thickness of the sub spacer SP. The main spacers MP may be disposed between the insulating layer IN1 and the insulating layer IN2 and contact the insulating layer IN1 and the insulating layer IN2. The sub spacers SP may be disposed between the insulating layer IN1 and the insulating layer IN2 and contact at least one of the insulating layer IN1 and the insulating layer IN2. In the present embodiment, the spacers PS (including the main spacers MP and the sub spacers SP) may be disposed to overlap the island portions IS of the first substrate SB1 and/or the second substrate SB2, but not limited thereto. In the top view direction of the first reflective panel RP1, the spacers PS may not overlap the first electrodes E1 and the second electrodes E2. The disposition positions of the spacers PS shown in FIG. 2 is exemplary, it is not limited in the present embodiment. The spacer PS may include a photo spacer, but not limited thereto. Through the disposition of the spacers PS, the situation of excessive variation in thickness of the first liquid crystal layer LC1 during the stretching process of the stretchable electronic device ED may be reduced, thereby improving the quality of the stretchable electronic device ED. In some embodiments, the spacer PS may be disposed at any suitable position corresponding to the first liquid crystal layer LC1. The spacers PS may overlap the bridge portions BR of the first substrate SB1 and/or the second substrate SB2 or the opening region OPR of the first reflective panel RP1.

In the manufacturing process of the first reflective panel RP1, the first substrate SB1 may be provided at first, and the insulating layer IN1 may be disposed on the first substrate SB1, and then the first electrodes E1 may be disposed on the insulating layer IN1, thereby forming a first structure. The manufacturing process of the first structure further includes disposing the first material layer MT1 in the first opening OP1 of the first substrate SB1 and the opening OPa of the insulating layer IN1, depending on whether the first substrate SB1 is patterned or not. In addition, the second substrate SB2 may be provided, the insulating layer IN2 may be disposed on the second substrate SB2, and the second electrodes E2 may be disposed on the insulating layer IN2 to form a second structure. The manufacturing process of the second structure further includes disposing the second material layer MT2 in the second opening OP2 of the second substrate SB2, the opening OPb of the insulating layer IN2 and/or the opening OPc of the second electrode E2, depending on whether the second substrate SB2 is patterned or not. In some embodiments, the manufacturing processes of the first structure and the second structure further include disposing the spacers PS on the insulating layer IN1 or the insulating layer IN2. After that, the first frame glue FG1 may be disposed on the first structure or the second structure, and the first liquid crystal layer LC1 may be disposed in the region RG enclosed by the first frame glue FG1. In some embodiments, the first frame glue FG1 and the first liquid crystal layer LC1 may be disposed on the first substrate SB1 and/or the first material layer MT1 at first. In some embodiments, the first frame glue FG1 and the first liquid crystal layer LC1 may be disposed on the second substrate SB2 and/or the second material layer MT2 at first. The first frame glue FG1 may be disposed along the outer edge of the first substrate SB1 or the second substrate SB2. After the first frame glue FG1 and the first liquid crystal layer LC1 are disposed, the first structure and the second structure may be combined to form the first reflective panel RP1. By patterning the first substrate SB1 and/or the second substrate SB2 of the first reflective panel RP1, the stretchable electronic device ED may have flexibility (for example, the stretchable electronic device ED may be stretched). In addition, by disposing the first material layer MT1 and/or the second material layer MT2 in the first opening OP1 of the first substrate SB1 and/or the second opening OP2 of the second substrate SB2, the flexibility of the stretchable electronic device ED may be improved. Moreover, by disposing the first material layer MT1 and/or the second material layer MT2, leakage of the first liquid crystal layer LC1 may be prevented when the first substrate SB1 and/or the second substrate SB2 are patterned, thereby improving the reliability of the first reflective panel RP1. It should be noted that the manufacturing process of the first reflective panel RP1 may further include other suitable steps and is not limited to the contents mentioned above.

According to the present embodiment, the first reflective panel RP1 may further include a bonding pad BP disposed on the first substrate SB1, but not limited thereto. The bonding pad BP may include any suitable conductive material, such as metal materials, but not limited thereto. The bonding pad BP may be used to electrically connect the conductive elements or wires (such as the conductive units MU, but not limited thereto) in the first reflective panel RP1 to an external electronic element OE. The conductive units MU in the first reflective panel RP1 may be electrically connected to the bonding pad BP, and the external electronic element OE may be electrically connected to the bonding pad BP through a flexible electronic element FE and a contact element CT. Therefore, the conductive units MU may be electrically connected to the external electronic element OE, and the external electronic element OE may provide electrical signals to the conductive units MU to control the driving of the liquid crystal molecules LCM. The flexible electronic element FE may include a flexible printed circuit board (FPCB), and the external electronic element OE may for example include a printed circuit board, but not limited thereto. The conductive units MU in the first reflective panel RP1 may be electrically connected to any number of external electronic elements OE. As shown in FIG. 1, the plurality of conductive units MU (not shown) in the first reflective panel RP1 may respectively be electrically connected to different external electronic elements OE through different flexible electronic elements FE, but not limited thereto. In such condition, different external electronic elements OE may for example be used to respectively provide scan signals or data signals. In addition, the first reflective panel RP1 may further include other electronic units electrically connected to the external electronic element OE.

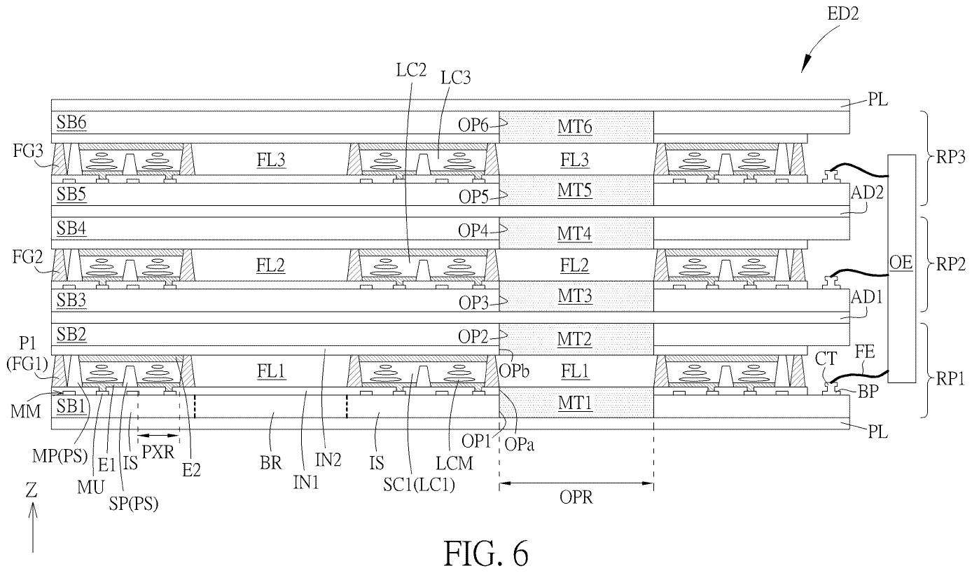

According to the present embodiment, the stretchable electronic device ED may further include a second reflective panel RP2 disposed at a side (for example, the upper side) of the first reflective panel RP1. The structure of the second reflective panel RP2 may be the same as the structure of the first reflective panel RP1. The second reflective panel RP2 may include a third substrate SB3, a fourth substrate SB4 opposite to the third substrate SB3, a second liquid crystal layer LC2 disposed between the third substrate SB3 and the fourth substrate SB4, and a second frame glue FG2 disposed between the third substrate SB3 and the fourth substrate SB4 and adjacent to the second liquid crystal layer LC2, but not limited thereto. As shown in FIG. 2, the third substrate SB3 may be patterned to have at least one third opening OP3. The second reflective panel RP2 may further include a third material layer MT3 disposed in at least one third opening OP3 of the third substrate SB3. The coefficient of elasticity of the material of the third material layer MT3 may be greater than the coefficient of elasticity of the material of the third substrate SB3. The fourth substrate SB4 may be patterned to have at least one fourth opening OP4. The second reflective panel RP2 may further include a fourth material layer MT4 disposed in the fourth opening OP4 of the fourth substrate SB4. The coefficient of elasticity of the material of the fourth material layer MT4 may be greater than the coefficient of elasticity of the material of the fourth substrate SB4. The materials of the third substrate SB3 and the fourth substrate SB4 may refer to the material of the first substrate SB1 mentioned above. The materials of the third material layer MT3 and the fourth material layer MT4 may refer to the material of the first material layer MT1 mentioned above. In some embodiments, only one of the third substrate SB3 and the fourth substrate SB4 may be patterned. The patterns of the third substrate SB3 and the fourth substrate SB4 may be the same as the patterns of the first substrate SB1 and the second substrate SB2. In such condition, the third opening OP3 and the fourth opening OP4 may correspond to or overlap the first opening OP1 of the first substrate SB1 and the second opening OP2 of the second substrate SB2, and the third material layer MT3 and the fourth material layer MT4 may correspond to or overlap the first material layer MT1 and the second material layer MT2. The disposition range of the second frame glue FG2 may refer to the disposition range of the first frame glue FG1 mentioned above. In the stretchable electronic device ED of the present embodiment, the lower substrate (that is, the third substrate SB3) of the second reflective panel RP2 and the upper substrate (that is, the second substrate SB2) of the first reflective panel RP1 are actually the same substrate, that is, the first reflective panel RP1 and the second reflective panel RP2 share a substrate, but not limited thereto. Therefore, as shown in FIG. 2, the second substrate SB2 may also be regarded as the third substrate SB3, the second material layer MT2 may also be regarded as the third material layer MT3, and the second opening OP2 may also be regarded as the third opening OP3. In such condition, the second material layer MT2 (or the third material layer MT3) may be disposed in the first reflective panel RP1 and the second reflective panel RP2. Specifically, the second material layer MT2 (or the third material layer MT3) may be disposed in the opening OPc of the second electrode E2, the opening OPb of the insulating layer IN2 and/or the second opening OP2 of the second substrate SB2 of the first reflective panel RP1, and the second material layer MT2 (or the third material layer MT3) may further be disposed in the third opening OP3 of the third substrate SB3 and/or the opening OPd of the insulating layer IN1 of the second reflective panel RP2, but not limited thereto. That is, the second material layer MT2 (or the third material layer MT3) may be disposed between the first liquid crystal layer LC1 and the second liquid crystal layer LC2 and contact the first liquid crystal layer LC1 and the second liquid crystal layer LC2, and the second material layer MT2 (or the third material layer MT3) may separate the first liquid crystal layer LC1 and the second liquid crystal layer LC2. In some embodiments, the second substrate SB2 of the first reflective panel RP1 and the third substrate SB3 of the second reflective panel RP2 may be different substrates, and the second substrate SB2 and the third substrate SB3 may be adhered to each other through a suitable adhesive layer (for example, shown in FIG. 6). In such condition, the second substrate SB2 and the third substrate SB3 may be different substrates, the second material layer MT2 and the third material layer MT3 may be different layers, and the second opening OP2 and the third opening OP3 may be different openings. Referring to FIG. 6, an adhesive layer AD1 may be disposed between the second substrate SB2 and the third substrate SB3, and the adhesive layer AD1 may be disposed between the second material layer MT2 and the third material layer MT3. The adhesive layer AD1 is disposed between the first reflective panel RP1 and the second reflective panel RP2 and is used to fix the first reflective panel RP1 and the second reflective panel RP2. The above-mentioned features of the third substrate SB3 and the fourth substrate SB4 may be applied to the embodiment in which the second substrate SB2 and the third substrate SB3 are different substrates. The structures and disposition ways of other elements and layers of the second reflective panel RP2 may refer to the structure of the first reflective panel RP1 mentioned above, and will not be redundantly described.

According to the present embodiment, as shown in FIG. 2, the stretchable electronic device ED may further include a third reflective panel RP3 disposed at a side (the upper side) of the second reflective panel RP2. The structure of the third reflective panel RP3 may be the same as the structure of the first reflective panel RP1. The third reflective panel RP3 may include a fifth substrate SB5, a sixth substrate SB6 opposite to the fifth substrate SB5, a third liquid crystal layer LC3 disposed between the fifth substrate SB5 and the sixth substrate SB6, and a third frame glue FG3 disposed between the fifth substrate SB5 and the sixth substrate SB6 and adjacent to the third liquid crystal layer LC3, but not limited thereto. The fifth substrate SB5 may be patterned to have at least one fifth opening OP5, and the third reflective panel RP3 may further include a fifth material layer MT5 disposed in the fifth opening OP5, but not limited thereto. The sixth substrate SB6 may be patterned to have at least one sixth opening OP6, and the third reflective panel RP3 may further include a sixth material layer MT6 disposed in the sixth opening OP6, but not limited thereto. The coefficient of elasticity of the fifth material layer MT5 may be greater than the coefficient of elasticity of the fifth substrate SB5, and the coefficient of elasticity of the sixth material layer MT6 may be greater than the coefficient of elasticity of the sixth substrate SB6. The materials of the fifth substrate SB5 and the sixth substrate SB6 may refer to the material of the first substrate SB1 mentioned above. The materials of the fifth material layer MT5 and the sixth material layer MT6 may refer to the material of the first material layer MT1 mentioned above. The patterns of the fifth substrate SB5 and the sixth substrate SB6 may be substantially the same as the patterns of the first substrate SB1, the second substrate SB2, the third substrate SB3 and the fourth substrate SB4. In such condition, the fifth opening OP5 and the sixth opening OP6 may correspond to or overlap the first opening OP1, the second opening OP2, the third opening OP3 and the fourth opening OP4, or the fifth material layer MT5 and the sixth material layer MT6 may correspond to or overlap the first material layer MT1, the second material layer MT2, the third material layer MT3 and the fourth material layer MT4. The disposition range of the third frame glue FG3 may refer to the disposition range of the first frame glue FG1 mentioned above. It should be noted that in the stretchable electronic device ED of the present embodiment, the upper substrate (that is, the fourth substrate SB4) of the second reflective panel RP2 and the lower substrate (that is, the fifth substrate SB5) of the third reflective panel RP3 may be the same substrate. Therefore, the fourth substrate SB4 may also be regarded as the fifth substrate SB5, the fourth material layer MT4 may also be regarded as the fifth material layer MT5, and the fourth opening OP4 may also be regarded as the fifth opening OP5. In some embodiments, the fourth substrate SB4 of the second reflective panel RP2 and the fifth substrate SB5 of the third reflective panel RP3 may be different substrates, and the fourth substrate SB4 and the fifth substrate SB5 may be adhered to each other through a suitable adhesive layer. In such condition, the fourth substrate SB4 and the fifth substrate SB5 may be different substrates, the fourth material layer MT4 and the fifth material layer MT5 may be different material layers, and the fourth opening OP4 and the fifth opening OP5 may be different openings. The above-mentioned features of the fifth substrate SB5 and the sixth substrate SB6 may be applied to the embodiment in which the fourth substrate SB4 and the fifth substrate SB5 are different substrates. The features of other elements and layers of the third reflective panel RP3 may refer to the structure of the first reflective panel RP1 mentioned above, and will not be redundantly described.

In the present embodiment, since the second substrate SB2 of the first reflective panel RP1 and the third substrate SB3 of the second reflective panel RP2 are the same substrate, and the fourth substrate SB4 of the second reflective panel RP2 and the fifth substrate SB5 of the third reflective panel RP3 are the same substrate, the stretchable electronic device ED may include four substrates, but not limited thereto. In some embodiments, when the second reflective panel RP2 is attached to the first reflective panel RP1 through an adhesive layer, and the third reflective panel RP3 is attached to the second reflective panel RP2 through an adhesive layer, the stretchable electronic device ED may include six substrates. As shown in FIG. 2, the conductive units MU in the first reflective panel RP1, the conductive units MU in the second reflective panel RP2 and the conductive units MU in the third reflective panel RP3 may be electrically connected to the same external electronic element OE respectively through the bonding pads BP in different reflective panels and different flexible electronic elements FE, but not limited thereto. In some embodiments, the conductive units MU in different reflective panels may be electrically connected to different external electronic elements OE. It should be noted that the stacking way of the reflective panels mentioned above may be applied to the electronic devices of the embodiments and variant embodiments of the present disclosure.

According to the present embodiment, the stretchable electronic device ED may include a structure formed by stacking three reflective panels, wherein the reflective panels may respectively reflect lights of different colors. Specifically, the first liquid crystal layer LC1 (for example, including cholesteric liquid crystal) of the first reflective panel RP1 may reflect light of a first color in a reflective state, the second liquid crystal layer LC2 (for example, including cholesteric liquid crystal) of the second reflective panel RP2 may reflect light of a second color in a reflective state, and the third liquid crystal layer LC3 (for example, including cholesteric liquid crystal) of the third reflective panel RP3 may reflect light of a third color in a reflective state, wherein the first color, the second color, and the third color may be different from each other. For example, the first color, the second color and the third color may respectively be red, green and blue, but not limited thereto. Although it is not shown in FIG. 2, the stretchable electronic device ED may further include a (black) absorption layer or a (black) absorption element disposed below the first reflective panel RP1 or disposed between the first substrate SB1 and the first liquid crystal layer LC1. It should be noted that the first color, the second color and the third color may respectively be other suitable colors and are not limited to the colors mentioned above. In some embodiments, the stretchable electronic device ED may include a reflective panel, such as one of the first reflective panel RP1, the second reflective panel RP2 and the third reflective panel RP3. In such condition, the stretchable electronic device ED may display images of the color of the light reflected by the liquid crystal layer of the reflective panel included in the stretchable electronic device ED. For example, when the stretchable electronic device ED only includes the first reflective panel RP1, the stretchable electronic device ED may display red images, but not limited thereto. In some embodiments, the stretchable electronic device ED may include any number of reflective panels. The quantity features of the reflective panel in the stretchable electronic device ED mentioned above may be applied to the electronic devices of the embodiments and variant embodiments of the present disclosure.

According to the present embodiment, the stretchable electronic device ED may further include protecting layers PL disposed at two sides of the stretchable electronic device ED. As shown in FIG. 2, the stretchable electronic device ED may include two protecting layers PL respectively disposed below the first reflective panel RP1 and disposed on the third reflective panel RP3. That is, one of the protecting layers PL may be disposed at a side of the first substrate SB1 away from the first liquid crystal layer LC1, and another one of the protecting layer PL may be disposed at a side of the sixth substrate SB6 away from the third liquid crystal layer LC3. The material of the protecting layers PL may be different from the material of the substrates (for example, the first substrate SB1 to the sixth substrate SB6) of the reflective panels. The coefficient of elasticity of the protecting layer PL may be greater than the coefficient of elasticity of the substrates (for example, the first substrate SB1, but not limited thereto) of the reflective panels. The protecting layer PL may include any suitable (organic) insulating material, but not limited thereto. In the present embodiment, the protecting layers PL may be completely disposed below the first reflective panel RP1 and disposed on the third reflective panel RP3. In the top view direction of the stretchable electronic device ED, the protecting layer PL may overlap at least one first opening OP1 of the first substrate SB1. In some embodiments, the protecting layer PL disposed below the first reflective panel RP1 may include a black material and may replace the black absorption layer mentioned above. In such condition, no additional black absorption layer is disposed in the stretchable electronic device ED.

It should be noted that the stretchable electronic device ED of the present embodiment may further include other suitable elements and layers, which is not limited to the structure shown in FIG. 2. Other embodiments of the present disclosure will be described in the following. In order to simplify the description, the same elements or layers in the following embodiments would be labeled with the same symbol, and the features thereof will not be redundantly described. The differences between the embodiments will be detailed in the following.

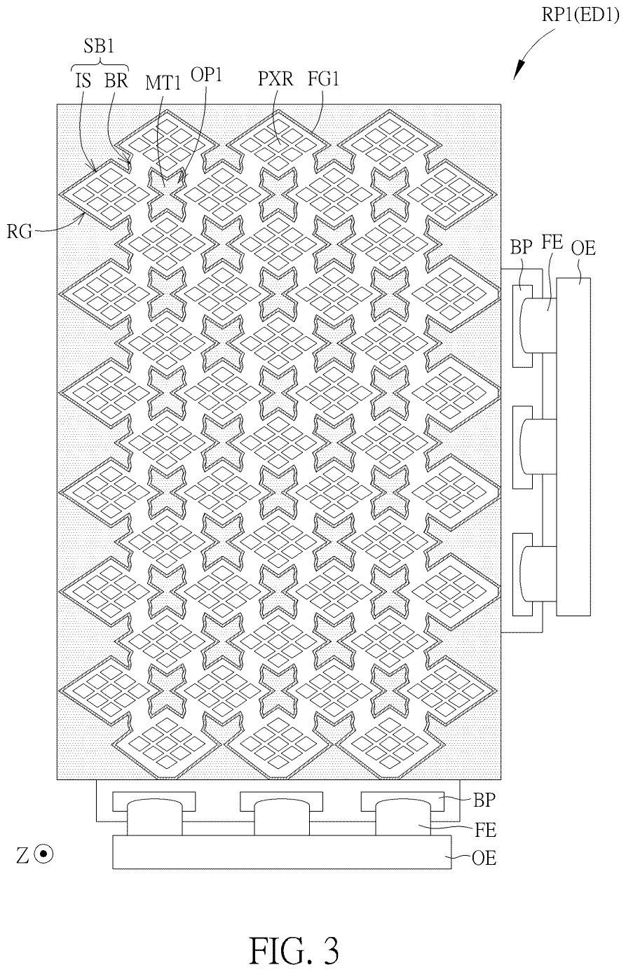

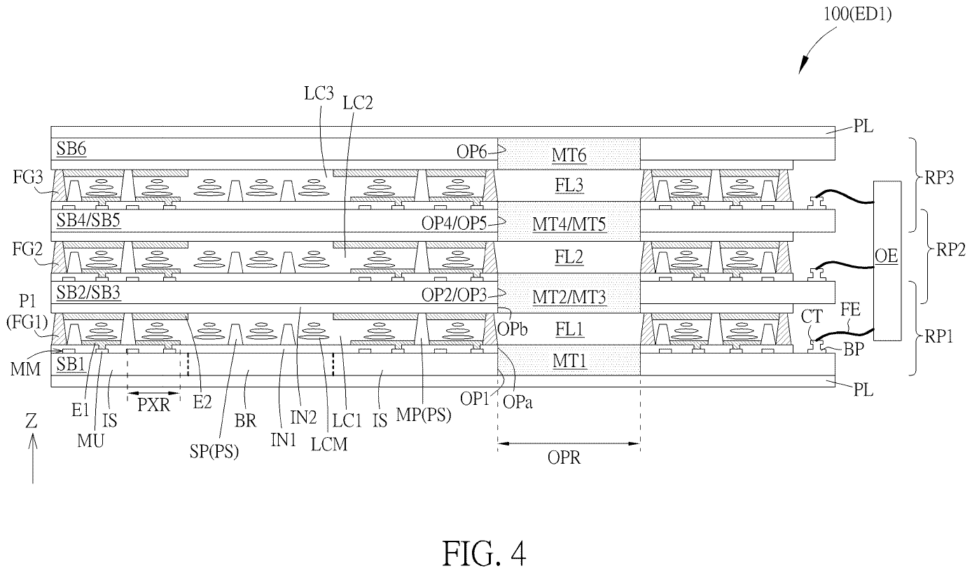

Referring to FIG. 3 and FIG. 4, FIG. 3 schematically illustrates a top view of an electronic device according to a second embodiment of the present disclosure, and FIG. 4 schematically illustrates a cross-sectional view of the electronic device according to the second embodiment of the present disclosure. It should be noted that FIG. 3 only exemplarily shows a top view of a reflective panel (for example, the first reflective panel RP1) in the stretchable electronic device ED1, and the top view structures of other reflective panels may refer to the top view structure of the first reflective panel RP1. One of the main differences between the stretchable electronic device ED1 of the present embodiment and the stretchable electronic device ED shown in FIG. 2 is the disposition position of the frame glue. Specifically, in the reflective panel of the stretchable electronic device ED1, the frame glue may be disposed along the outer edge of the substrate. For example, as shown in FIG. 3, in the first reflective panel RP1 of the stretchable electronic device ED1, the first frame glue FG1 may be disposed along the outer edge of the first substrate SB1 (or the second substrate SB2). “The outer edge of the first substrate SB1” described herein may include the outer edges of the island portions IS and the outer edges of the bridge portions BR of the first substrate SB1. The first frame glue FG1 may be disposed on the first substrate SB1 and extend along the outer edge of the first substrate SB1 to enclose the region RG, wherein the region RG may substantially correspond to the first substrate SB1. The first liquid crystal layer LC1 may correspond to or overlap the region RG, that is, the first frame glue FG1 may surround the first liquid crystal layer LC1. Through the position design of the first frame glue FG1 mentioned above, the first liquid crystal layer LC1 may be disposed to correspond to or overlap the island portions IS and the bridge portions BR of the first substrate SB1. The portions of the first liquid crystal layer LC1 corresponding to different island portions IS may be connected to each other through the bridge portions BR, or in other words, the first liquid crystal layer LC1 may flow between different island portions IS through the bridge portions BR. In addition, the first liquid crystal layer LC1 may not overlap the opening region OPR of the first reflective panel RP1. That is, in the top view direction of the stretchable electronic device ED1, the first liquid crystal layer LC1 may not overlap the first opening OP1 of the first substrate SB1. The first liquid crystal layer LC1 may be disposed not overlapping the first material layer MT1 disposed in the first opening OP1. The first liquid crystal layer LC1 may not contact the first material layer MT1. In the stretchable electronic device ED1, the position designs of the second frame glue FG2 and the second liquid crystal layer LC2 of the second reflective panel RP2 and the position designs of the third frame glue FG3 and the third liquid crystal layer LC3 of the third reflective panel RP3 may refer to the position designs of the first frame glue FG1 and the first liquid crystal layer LC1 mentioned above, and will not be redundantly described. Through the position designs of the frame glue and the liquid crystal layers mentioned above, the possibility of excessive variation in thickness of the liquid crystal layers during the deforming process of the stretchable electronic device ED1 may be reduced, thereby improving the performance of the stretchable electronic device ED1.

As shown in FIG. 4, the first reflective panel RP1 of the stretchable electronic device ED1 may further include a filling layer FL1, wherein the filling layer FL1 may be disposed on the first material layer MT1 and may be adjacent to the first frame glue FG1. Specifically, after the first frame glue FG1 is disposed to define the region RG, the first liquid crystal layer LC1 adjacent to the first frame glue FG1 may be disposed in the region RG, and the filling layer FL1 adjacent to the first frame glue FG1 may be disposed outside the region RG. In other words, the first frame glue FG1 may be disposed between the first liquid crystal layer LC1 and the filling layer FL1 and may separate the first liquid crystal layer LC1 and the filling layer FL1. The filling layer FL1 may overlap the opening region OPR (the first opening OP1 and/or the second opening OP2) of the first reflective panel RP1. The filling layer FL1 may be disposed to overlap the first material layer MT1 and/or the second material layer MT2. The filling layer FL1 may contact the first material layer MT1 and/or the second material layer MT2, but not limited thereto. In some embodiments, the filling layer FL1 may include a transparent material layer or an air layer. The transparent material layer may include any suitable transparent insulating material. In some embodiments, the filling layer FL1 may include the same material as the first material layer MT1 and/or the second material layer MT2.

Similarly, in the stretchable electronic device ED1, the second reflective panel RP2 may include a filling layer FL2 disposed outside the region enclosed by the second frame glue FG2 and adjacent to the second frame glue FG2, and the third reflective panel RP3 may include a filling layer FL3 disposed outside the region enclosed by the third frame glue FG3 and adjacent to the third frame glue FG3. The filling layer FL2, the third material layer MT3 and/or the fourth material layer MT4 may overlap the third opening OP3 and/or the fourth opening OP4. The filling layer FL3, the fifth material layer MT5 and/or the sixth material layer MT6 may overlap the fifth opening OP5 and/or the sixth opening OP6. Through the disposition way of the frame glue mentioned above, when the stretchable electronic device ED1 is stretched, the thickness uniformity of the liquid crystal layers in the reflective panels may be improved. It should be noted that in the present embodiment, the spacers PS (including the main spacers MP and the sub spacers SP) in the reflective panel may optionally overlap the bridge portions BR of the substrate in addition to being overlapped with the island portions IS of the substrate, but not limited thereto.

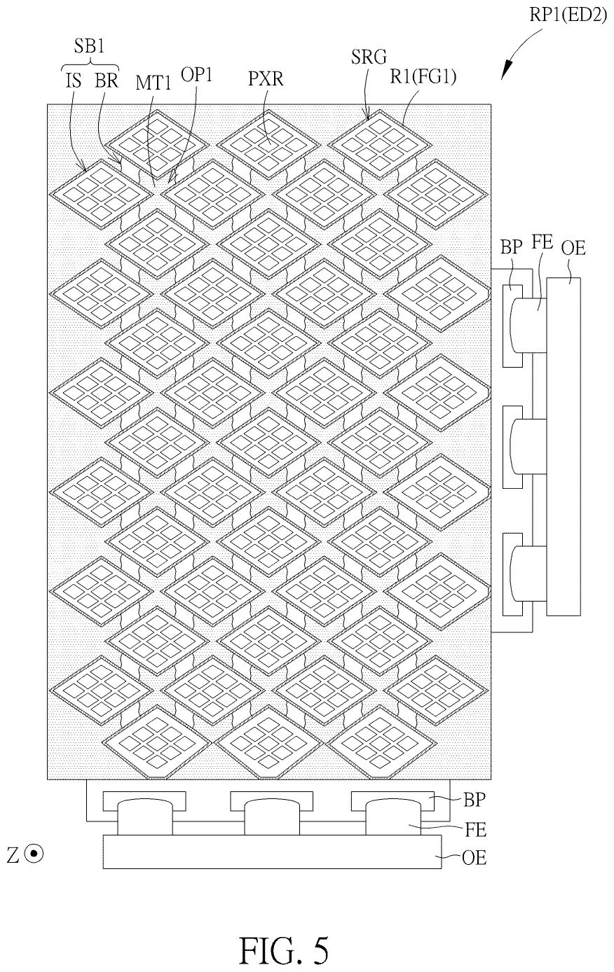

Referring to FIG. 5 and FIG. 6, FIG. 5 schematically illustrates a top view of an electronic device according to a third embodiment of the present disclosure, and FIG. 6 schematically illustrates a cross-sectional view of the electronic device according to the third embodiment of the present disclosure. FIG. 5 only exemplarily shows a top view of a reflective panel (for example, the first reflective panel RP1) in the stretchable electronic device ED2, and the top view structures of other reflective panels may refer to the top view structure of the first reflective panel RP1. One of the main differences between the stretchable electronic device ED2 of the present embodiment and the stretchable electronic device ED shown in FIG. 2 is the disposition position of the frame glue. Specifically, in the reflective panel of the stretchable electronic device ED2, the frame glue may be disposed to overlap the island portions IS of the substrate. For example, the frame glue may be disposed along the outer edges of the island portions IS. As shown in FIG. 5, the first frame glue FG1 in the first reflective panel RP1 may be disposed along the outer edges of the island portions IS of the first substrate SB1. The first frame glue FG1 may include a plurality of annular portions R1, and the annular portions R1 may respectively overlap the island portions IS of the first substrate SB1. An annular portion R1 may for example be disposed along the outer edge of an island portion IS. The annular portions R1 may be separated from each other, or the annular portions R1 may not contact each other. An annular portion R1 may surround the pixel region PXR (or the first electrode E1) on the island portion IS to which it corresponds. In the present embodiment, each annular portion R1 may enclose a sub region SRG, and the sub region SRG corresponds to one of the island portions IS. The first liquid crystal layer LC1 may be disposed corresponding to the sub regions SRG enclosed by the annular portions R1. The first liquid crystal layer LC1 may include a plurality of sub liquid crystal layer portions SC1, wherein the sub liquid crystal layer portions SC1 may be disposed to respectively correspond to or overlap the sub regions SRG. In detail, a sub liquid crystal layer portion SC1 may for example be disposed to correspond to or overlap a sub region SRG. The annular portions R1 of the first frame glue FG1 respectively surround the sub liquid crystal layer portions SC1 of the first liquid crystal layer LC1, and the sub liquid crystal layer portions SC1 are not connected to each other. The first liquid crystal layer LC1 may be disposed to correspond to or overlap the island portions IS, but not be disposed to correspond to or overlap the bridge portions BR. In addition, the first liquid crystal layer LC1 is disposed to not correspond to or not overlap the opening region OPR. That is, in the top view direction of the stretchable electronic device ED2, the first liquid crystal layer LC1 does not overlap at least one first opening OP1 and/or at least one second opening OP2, and the first liquid crystal layer LC1 does not overlap the first material layer MT1 and/or the second material layer MT2. As shown in FIG. 6, the first reflective panel RP1 may further include a filling layer FL1 disposed outside the sub regions SRG and adjacent to the annular portions R1 of the first frame glue FG1. Specifically, the filling layer FL1 may be disposed to correspond to or overlap the bridge portions BR of the first substrate SB1 and the opening region OPR. In other words, the filling layer FL1 may be disposed between the plurality of annular portions R1 of the first frame glue FG1. The filling layer FL1 includes a transparent material layer or an air layer, and the detail thereof may refer to the contents mentioned above, which will not be redundantly described. The disposition ways of the second frame glue FG2, the second liquid crystal layer LC2 and the filling layer FL2 in the second reflective panel RP2 and the disposition ways of the third frame glue FG3, the third liquid crystal layer LC3 and the filling layer FL3 in the third reflective panel RP3 may refer to the contents mentioned above, and will not be redundantly described. Through the disposition way of the frame glue mentioned above, the liquid crystal layer may be prevented from flowing between the island portions IS, thereby improving the thickness uniformity of the liquid crystal layers in the reflective panels when the stretchable electronic device ED2 is stretched.

In the present embodiment, the stretchable electronic device ED2 may further include an adhesive layer AD1 disposed between the second substrate SB2 and the third substrate SB3 and an adhesive layer AD2 disposed between the fourth substrate SB4 and the fifth substrate SB5, but not limited thereto. The adhesive layer AD1 may be used to adhere the first reflective panel RP1 to the second reflective panel RP2, and the adhesive layer AD2 may be used to adhere the second reflective panel RP2 to the third reflective panel RP3. The adhesive layer AD1 and the adhesive layer AD2 may include any suitable adhesive, such as optical clear adhesive (OCA), but not limited thereto. In some embodiments (as shown in FIG. 2), the second substrate SB2 and the third substrate SB3 may be the same substrate, and the fourth substrate SB4 and the fifth substrate SB5 may be the same substrate.

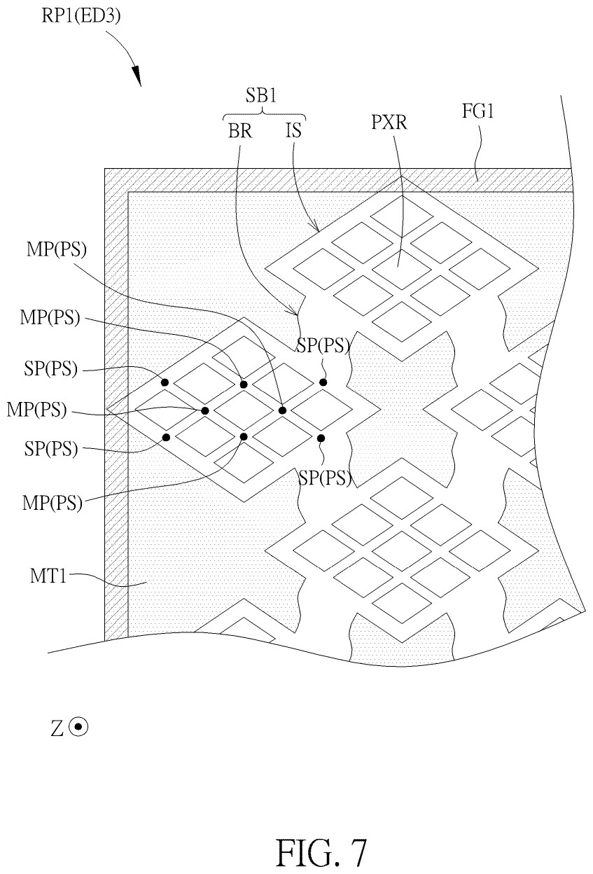

Referring to FIG. 7, FIG. 7 schematically illustrates a top view of an electronic device according to a fourth embodiment of the present disclosure. FIG. 7 only shows a top view of a reflective panel (for example, the first reflective panel RP1) in the stretchable electronic device ED3. According to the present embodiment, in the reflective panels of the stretchable electronic device ED3, the main spacers MP of the spacers PS may be disposed substantially in the central region of the island portion IS, and the sub spacers SP of the spacers PS may be disposed in the peripheral region of the island portion IS, but not limited thereto. As shown in FIG. 7, the main spacers MP may be disposed between four pixel regions PXR or between four first electrodes E1; the sub spacers SP may be disposed between the pixel region PXR (or the first electrode E1) and the outer edge of the island portion IS or between the pixel region PXR and the bridge portions BR. In the top view direction of the stretchable electronic device ED3, the main spacers MP may be surrounded by the pixel regions PXR (or the first electrodes E1), and the sub spacers SP may be adjacent to the outermost pixel regions PXR (or the outer edges of the first electrodes E1). The disposition way of the spacer PS shown in FIG. 7 may be applied to the electronic devices of the embodiments and variant embodiments of the present disclosure. The disposition way of the first frame glue FG1 in the first reflective panel RP1 shown in FIG. 7 is exemplary, wherein the first frame glue FG1 may be disposed in any one of the disposition ways mentioned above.

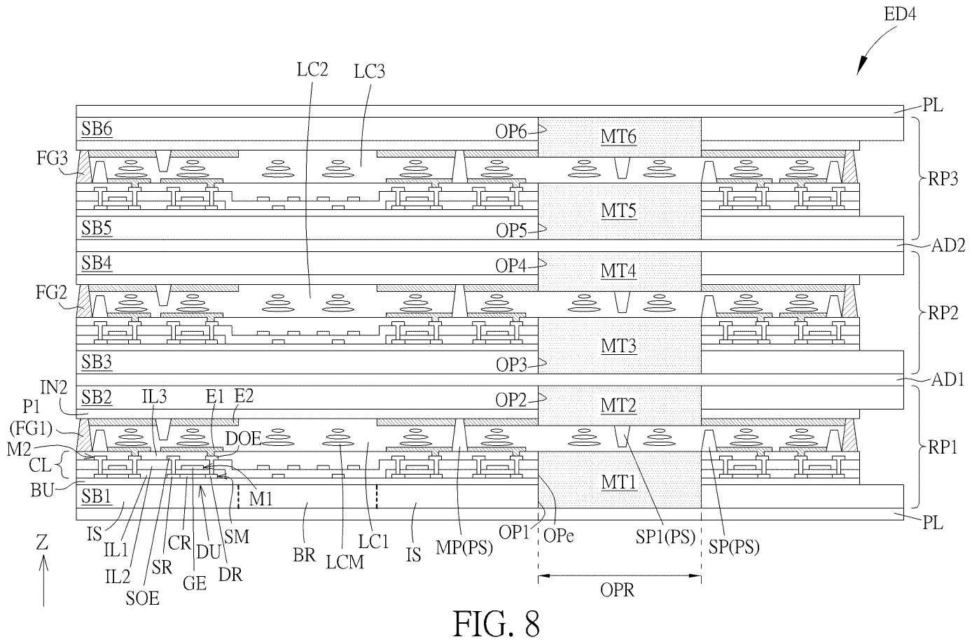

Referring to FIG. 8, FIG. 8 schematically illustrates a cross-sectional view of an electronic device according to a fifth embodiment of the present disclosure. In order to simplify the figure, the bonding pads on the reflective panels, the flexible electronic elements and the external electronic element are omitted in FIG. 8. One of the main differences between the stretchable electronic device ED4 of the present embodiment and the stretchable electronic device ED shown in FIG. 2 is the driving way of the reflective panel. The driving way of the reflective panels in the stretchable electronic device ED4 may be active driving. As shown in FIG. 8, the first reflective panel RP1 of the stretchable electronic device ED4 may include a circuit layer CL disposed between the first substrate SB1 and the first electrodes E1. The first reflective panel RP1 may further include a buffer layer BU disposed on the first substrate SB1, and the circuit layer CL may be disposed on the buffer layer BU. The circuit layer CL may replace the insulating layer IN1 and the conductive layer MM in the stretchable electronic device ED mentioned above. The circuit layer CL may include various kinds of wires, circuits and electronic units that can be applied to the first reflective panel RP1. The circuit layer CL may include any suitable structure formed by stacking conductive layer(s) and insulating layer(s), wherein the conductive layer(s) may be used to form the above-mentioned wires, circuits or electronic units. The circuit layer CL may include driving units DU, and the driving units DU may be electrically connected to the first electrodes E1. The driving unit DU may include a transistor, such as a thin film transistor (TFT). By driving the first reflective panel RP1 in an active driving way, the response speed of the first reflective panel RP1 may be reduced. As shown in FIG. 8, the circuit layer CL may include a semiconductor layer SM, a conductive layer M1 and a conductive layer M2. The semiconductor layer SM may form a channel region CR, a source region SR and a drain region DR of the driving unit DU. The conductive layer M1 may form a gate electrode GE of the driving unit DU. The channel region CR may be defined as a portion of the semiconductor layer SM overlapping the gate electrode GE. The conductive layer M2 is located on the conductive layer M1 and may form a source electrode SOE and a drain electrode DOE electrically connected to the source region SR and the drain region DR respectively. The conductive layer M1 and the conductive layer M2 may include any suitable conductive material, such as metal materials, but not limited thereto. The circuit layer CL may further include an insulating layer IL1 disposed between the semiconductor layer SM and the conductive layer M1, an insulating layer IL2 disposed between the conductive layer M1 and the conductive layer M2, and an insulating layer IL3 disposed on the insulating layer IL2. The insulating layer IL1, the insulating layer IL2 and the insulating layer IL3 may include any suitable insulating material. The insulating layer IL1 may be a gate insulating layer of the driving unit DU. In the present embodiment, the circuit layer CL may be disposed not corresponding to the opening region OPR. Specifically, the circuit layer CL may include an opening OPe corresponding to the opening region OPR. The opening OPe may for example be formed by removing portions of the insulating layer IL1, the insulating layer IL2, and the insulating layer IL3 corresponding to the opening region OPR. It should be noted that the circuit layer CL may further include other suitable elements or layers, which is not limited to what is shown in FIG. 8. The structure of the circuit layer CL shown in FIG. 8 is exemplary, it is not limited in the present embodiment. Similarly, in the stretchable electronic device ED4, the second reflective panel RP2 may include a circuit layer CL disposed between the third substrate SB3 and the first electrodes E1, and the third reflective panel RP3 may include a circuit layer CL disposed between the fifth substrate SB5 and the first electrodes E1, wherein the structures of the circuit layers CL may refer to the contents mentioned above, and will not be redundantly described.

In the present embodiment, a portion of the insulating layer(s) in the circuit layer CL may be patterned to be disposed not corresponding to the bridge portions BR of the substrate. Specifically, the portion of at least one inorganic insulating layer in the circuit layer CL corresponding to the bridge portions BR may be removed, so as to pattern the at least one inorganic insulating layer and make the at least one inorganic insulating layer correspond to the island portions IS of the substrate. As shown in FIG. 8, the insulating layer IL1 in the circuit layer CL may be patterned to remove a portion of the insulating layer IL1 corresponding to the bridge portions BR of the first substrate SB1, but not limited thereto. In some embodiments, the above-mentioned patterning process may also be performed on other insulating layers in the circuit layer CL. Through the above-mentioned design, the flexibility of the stretchable electronic device ED4 may be improved.

In the present embodiment, the spacers PS (including the main spacers MP and the sub spacers SP) in the reflective panel may be disposed corresponding to the opening region OPR in addition to being disposed to correspond to or overlap the island portions IS of the substrate. As shown in FIG. 8, the first reflective panel RP1 may further include a sub spacer SP1 disposed corresponding to the opening region OPR. The sub spacer SP1 may be disposed on a surface of the second material layer MT2 (or the first material layer MT1) adjacent to the first liquid crystal layer LC1, but not limited thereto. In some embodiments, the first reflective panel RP1 may include a main spacer MP disposed corresponding to the opening region OPR, wherein the main spacer MP may contact both the first material layer MT1 and the second material layer MT2. The dispositions of the spacers PS in the second reflective panel RP2 and the third reflective panel RP3 may refer to the contents mentioned above, and will not be redundantly described. By disposing the spacers PS corresponding to the opening region OPR in the reflective panel, the thickness uniformity of the liquid crystal layers may be improved when the stretchable electronic device ED4 is stretched.

In the present embodiment, the stretchable electronic device ED4 may further include an adhesive layer AD1 disposed between the second substrate SB2 and the third substrate SB3 and an adhesive layer AD2 disposed between the fourth substrate SB4 and the fifth substrate SB5, but not limited thereto. The adhesive layer AD1 may be used to adhere the first reflective panel RP1 to the second reflective panel RP2, and the adhesive layer AD2 may be used to adhere the second reflective panel RP2 to the third reflective panel RP3. The materials of the adhesive layer AD1 and the adhesive layer AD2 may refer to the contents mentioned above, and will not be redundantly described. In some embodiments, the second substrate SB2 and the third substrate SB3 may be the same substrate, and the fourth substrate SB4 and the fifth substrate SB5 may be the same substrate.

Although it is not shown in FIG. 8, the stretchable electronic device ED4 may further include a black matrix layer, wherein the black matrix layer may be disposed inside or outside the reflective panel. The black matrix layer may be disposed corresponding to the driving units DU in the circuit layer CL. Therefore, the possibility that the light is reflected by the driving units DU and observed by the user may be reduced, thereby improving the display function.

The details of other elements or layers in the reflective panels of the stretchable electronic device ED4 may refer to FIG. 2 and related contents mentioned above, and will not be redundantly described.

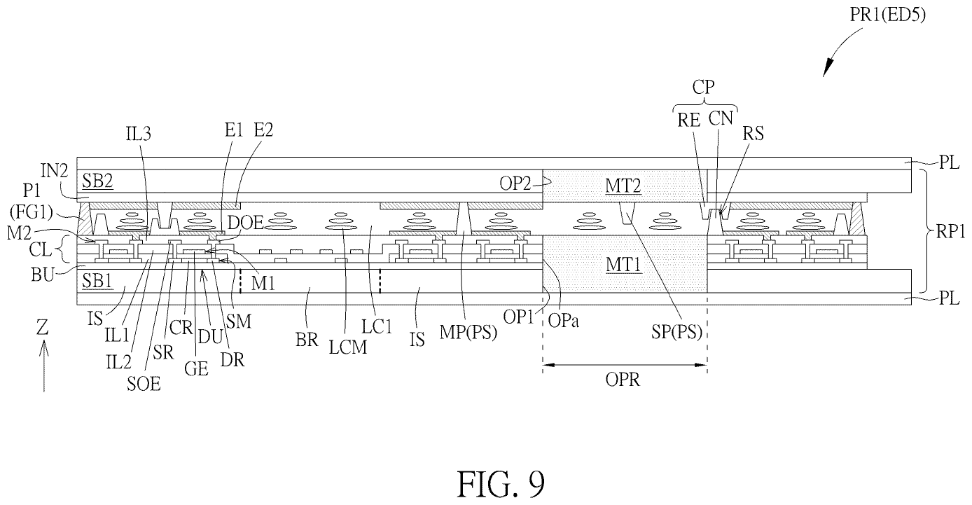

Referring to FIG. 9, FIG. 9 schematically illustrates a cross-sectional view of an electronic device according to a sixth embodiment of the present disclosure. The stretchable electronic device ED5 shown in FIG. 9 may include at least one reflective panel, such as the first reflective panel RP1, but not limited thereto. According to the present embodiment, the spacers PS in the first reflective panel RP1 may include composite spacers CP in addition to the main spacers MP and the sub spacers SP, wherein the composite spacers CP may be disposed at any suitable position not corresponding to the first electrodes E1 and the second electrodes E2. The composite spacer CP may include a concave portion RE and a columnar portion CN corresponding to each other, or the composite spacer CP may be composed of the concave portion RE and the columnar portion CN. The concave portion RE includes a cavity RS, and the columnar portion CN may be disposed in the cavity RS and contact the bottom surface of the cavity RS, but not limited thereto. In other words, the columnar portion CN may be embedded in the concave portion RE. The composite spacers CP may be disposed corresponding to the first liquid crystal layer LC1. In the stretchable electronic device ED5, the composite spacers CP may be disposed corresponding to the island portions IS and the bridge portions BR of the first substrate SB1 and/or the opening region OPR. When the composite spacer CP is disposed corresponding to the island portions IS or the bridge portions BR, one of the concave portion RE and the columnar portion CN of the composite spacer CP may be disposed on the insulating layer IN1, and the other one of the concave portion RE and the columnar portion CN may be disposed on the insulating layer IN2. When the composite spacer CP is disposed corresponding to the opening region OPR, one of the concave portion RE and the columnar portion CN of the composite spacer CP may be disposed on the first material layer MT1, and the other one of the concave portion RE and the columnar portion CN may be disposed on the second material layer MT2, as shown in FIG. 9, by disposing the composite spacers CP, the thickness uniformity of the liquid crystal layers in the reflective panels may be improved when the stretchable electronic device ED5 is stretched. The structure of the stretchable electronic device ED5 shown in FIG. 9 is exemplary, and the composite spacer CP mentioned in the present embodiment may be applied to the electronic devices of the embodiments and variant embodiments of the present disclosure.

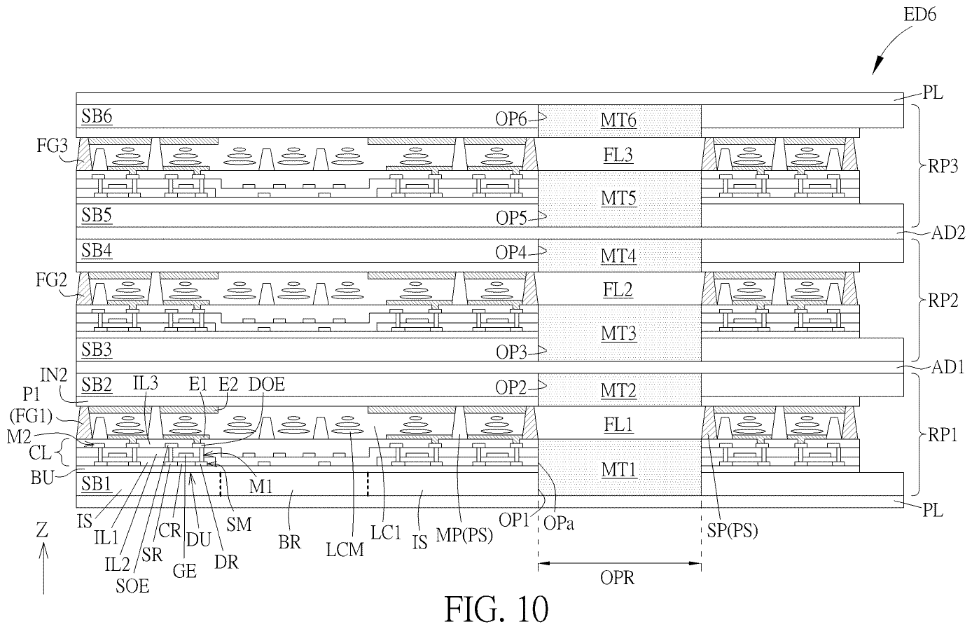

Referring to FIG. 10, FIG. 10 schematically illustrates a cross-sectional view of an electronic device according to a seventh embodiment of the present disclosure. In order to simplify the figure, the bonding pads on the reflective panels, the flexible electronic elements and the external electronic element are omitted in FIG. 10. One of the main differences between the stretchable electronic device ED6 of the present embodiment and the stretchable electronic device ED1 shown in FIG. 4 is that the reflective panels in the stretchable electronic device ED6 are driven by active driving. Specifically, in the stretchable electronic device ED6, the first reflective panel RP1 may include a circuit layer CL disposed between the first substrate SB1 and the first electrodes E1, the second reflective panel RP2 may include a circuit layer CL disposed between the third substrate SB3 and the first electrodes E1, and the third reflective panel RP3 may include a circuit layer CL disposed between the fifth substrate SB5 and the first electrodes E1, wherein the structures of these circuit layers CL may refer to the structure of the circuit layer CL in FIG. 8 above. The structure of the reflective panel in the stretchable electronic device ED6 may refer to the structure of the reflective panel shown in FIG. 4, and will not be redundantly described. It should be noted that the stretchable electronic device ED6 may further include an adhesive layer AD1 disposed between the second substrate SB2 and the third substrate SB3 and an adhesive layer AD2 disposed between the fourth substrate SB4 and the fifth substrate SB5, but not limited thereto. In some embodiments, the second substrate SB2 and the third substrate SB3 may be the same substrate, and the fourth substrate SB4 and the fifth substrate SB5 may be the same substrate.

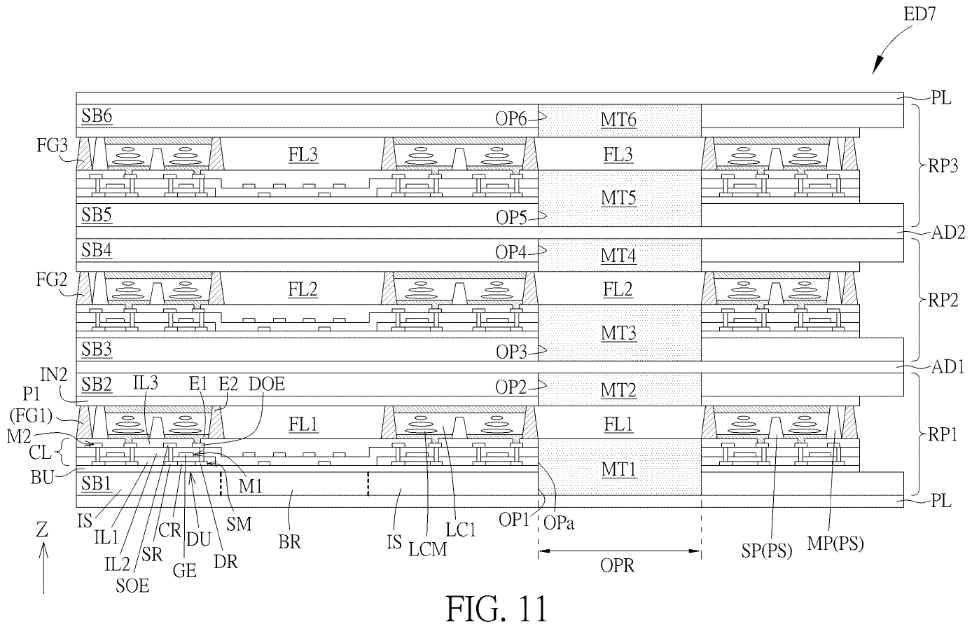

Referring to FIG. 11, FIG. 11 schematically illustrates a cross-sectional view of an electronic device according to an eighth embodiment of the present disclosure. In order to simplify the figure, the bonding pads on the reflective panels, the flexible electronic elements and the external electronic element are omitted in FIG. 11. One of the main differences between the stretchable electronic device ED7 of the present embodiment and the stretchable electronic device ED2 shown in FIG. 6 is that the reflective panels in the stretchable electronic device ED7 are driven by active driving. Specifically, in the stretchable electronic device ED7, the first reflective panel RP1 may include a circuit layer CL disposed between the first substrate SB1 and the first electrodes E1, the second reflective panel RP2 may include a circuit layer CL disposed between the third substrate SB3 and the first electrodes E1, and the third reflective panel RP3 may include a circuit layer CL disposed between the fifth substrate SB5 and the first electrodes E1, wherein the structures of these circuit layers CL may refer to the structure of the circuit layer CL in FIG. 8 above. The structure of the reflective panel in the stretchable electronic device ED7 may refer to the structure of the reflective panel shown in FIG. 6, and will not be redundantly described. It should be noted that the stretchable electronic device ED7 may further include an adhesive layer AD1 disposed between the second substrate SB2 and the third substrate SB3 and an adhesive layer AD2 disposed between the fourth substrate SB4 and the fifth substrate SB5, but not limited thereto. In some embodiments, the second substrate SB2 and the third substrate SB3 may be the same substrate, and the fourth substrate SB4 and the fifth substrate SB5 may be the same substrate.

In short, in the present disclosure, the driving way of the reflective panel of the stretchable electronic device may be one of the passive driving (shown in FIG. 1 to FIG. 6) and the active driving (shown in FIG. 8 to FIG. 11) and may include corresponding driving units. The disposition way of the frame glue in the reflective panel of the stretchable electronic device may be one of the disposition ways respectively shown in FIG. 1, FIG. 3 and FIG. 5. In other words, the stretchable electronic device of the present disclosure may be combinations of any one of the above-mentioned driving ways and any one of the above-mentioned disposition ways of the frame glue.

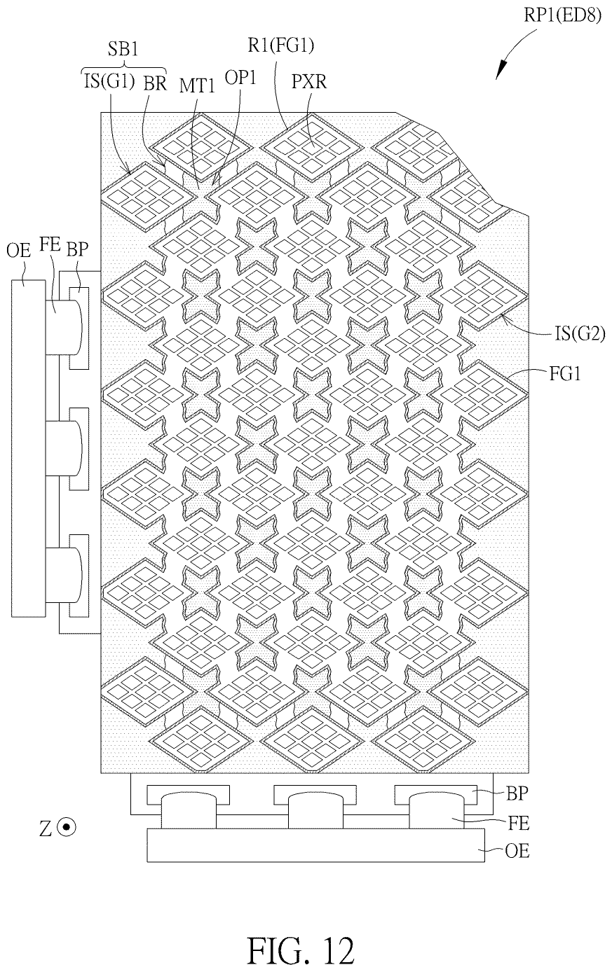

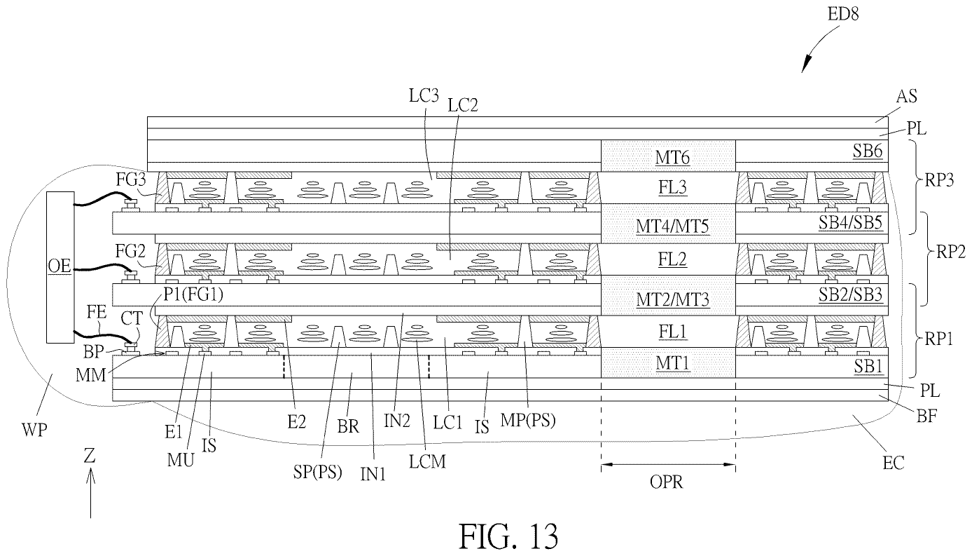

Referring to FIG. 12 and FIG. 13, FIG. 12 schematically illustrates a top view of an electronic device according to a ninth embodiment of the present disclosure, and FIG. 13 schematically illustrates a cross-sectional view of the electronic device according to the ninth embodiment of the present disclosure. It should be noted that FIG. 12 only exemplarily shows a top view of a reflective panel (for example, the first reflective panel RP1) in the stretchable electronic device ED8, and the top view structures of other reflective panels may refer to the top view structure of the first reflective panel RP1. According to the present embodiment, in the stretchable electronic device ED8, the frame glue in different regions of the reflective panel may be disposed in different ways. Specifically, taking the first reflective panel RP1 as an example, the first frame glue FG1 corresponding to at least a portion of the outermost island portions IS may be disposed along the outer edges of the island portions IS of the first substrate SB1, that is, having the disposition way shown in FIG. 5, and the first frame glue FG1 corresponding to other island portions IS may be disposed along the outer edge of the first substrate SB1, that is, having the disposition way shown in FIG. 3. In other words, the disposition way of the first frame glue FG1 corresponding to the outermost island portions IS may be different from the disposition way of the first frame glue FG1 corresponding to other island portions IS. The island portions IS of the first substrate SB1 may respectively be included in a first group G1 and a second group G2, wherein the first group G1 may include at least a portion of the outermost island portions IS, and the second group G2 may include other island portions IS except the island portions IS in the first group G1. As shown in FIG. 12, in some embodiments, the first group G1 may include all the outermost island portions IS, and the second group G2 may include the other island portions IS. A portion of the first frame glue FG1 may form a plurality of annular portions R1, and the annular portions R1 are respectively disposed along the outer edges of the island portions IS in the first group G1. Another portion of the first frame glue FG1 may be disposed along the outer edge of the first substrate SB1 (including the island portions IS and the bridge portions BR) and surround the island portions IS in the second group G2 and the bridge portions BR connecting the island portions IS in the second group G2. According to the present embodiment, the stretchable electronic device ED8 may be attached to any surface, such as a flat surface, a curved surface or a spherical surface, by processing methods such as stretching, cutting, and the like. For example, the stretchable electronic device ED8 may be attached to the surfaces of the car shell, the window or the dashboard as a vehicle display, but not limited thereto. Through the disposition way of the first frame glue FG1 mentioned above, the influence on the reliability of the stretchable electronic device ED8 when the stretchable electronic device ED8 is stretched or cut may be reduced. As shown in FIG. 12, when the stretchable electronic device ED8 is cut to match the size of the surface to which it is attached, the outermost island portions IS and the first frame glue FG1 disposed corresponding thereto may be damaged. However, through the disposition way of the first frame glue FG1 mentioned above, the portion of the first liquid crystal layer LC1 corresponding to the outermost island portions IS may be independent or not connected to other portions of the first liquid crystal layer LC1. Therefore, the possibility of severe leakage of the first liquid crystal layer LC1 caused by cutting the stretchable electronic device ED8 may be reduced, thereby improving the reliability of the stretchable electronic device ED8.

In the present embodiment, the stretchable electronic device ED8 may further include an anti-scratch layer AS disposed at a side of the stretchable electronic device ED8 that can be operated by the user. As shown in FIG. 13, the anti-scratch layer AS may be disposed on the third reflective panel RP3, but not limited thereto. In some embodiments, the anti-scratch layer AS may be disposed below the first reflective panel RP1. The anti-scratch layer AS may reduce the possibility of the surface of the stretchable electronic device ED8 being scratched. In some embodiments, the stretchable electronic device ED8 may not include the anti-scratch layer AS, and an anti-scratch treatment may be performed on the surface of the protecting layer PL disposed on the third reflective panel RP3.

In the present embodiment, the stretchable electronic device ED8 may further include a buffer layer BF disposed at a side of the stretchable electronic device ED8. Specifically, the buffer layer BF is disposed at a side of the stretchable electronic device ED8 attached to other surfaces. That is, when the stretchable electronic device ED8 is attached to a surface, the buffer layer BF may be disposed between the stretchable electronic device ED8 and the surface. As shown in FIG. 13, the buffer layer BF may for example be disposed below the first reflective panel RP1, but not limited thereto. The buffer layer BF and the anti-scratch layer AS may respectively be disposed at two sides of the stretchable electronic device ED8, but not limited thereto. The buffer layer BF may for example provide a shockproof effect for the stretchable electronic device ED8, thereby improving the reliability of the stretchable electronic device ED8.

In the present embodiment, the stretchable electronic device ED8 may further include a waterproof structure WP, wherein the waterproof structure WP may at least cover the external electronic element OE, the flexible electronic elements FE and/or the bonding pads BP and optionally contact a portion of the reflective panel. The description “disposing the waterproof structure WP” may include disposing any suitable waterproof material or performing a waterproof treatment. The waterproof structure WP may be used to block the moisture or air in the environment, such that the possibility of deterioration of the external electronic element OE, the flexible electronic elements FE and/or the bonding pads BP due to contact with moisture or air may be reduced, thereby improving the electrical connection between the electronic elements.

In the present embodiment, the stretchable electronic device ED8 may further include a wrapping layer EC, wherein the wrapping layer EC may wrap (or cover) the portions of the frame glues (including the first frame glue FG1, the second frame glue FG2 and the third frame glue FG3) exposed to the environment. Specifically, the wrapping layer EC may be used to isolate the frame glues from the external environment. For example, in the present embodiment, the wrapping layer EC may be disposed along the sides of the first reflective panel RP1, the second reflective panel RP2 and the third reflective panel RP3 and the bottom surface of the buffer layer BF, but not limited thereto. In such condition, the possibility of the frame glues being isolated from the external environment may increase through the waterproof structure WP and the wrapping layer EC, and leakage of the liquid crystal layers to the external environment may also be reduced. The disposition position of the wrapping layer EC shown in FIG. 13 is exemplary. The wrapping layer EC of the present embodiment may be disposed at any suitable position, such that the frame glues are not exposed to the external environment. In some embodiments, when the stretchable electronic device ED8 does not include the waterproof structure WP, the wrapping layer EC may further wrap (or cover) the frame glues shown in the left side of FIG. 13.

The disposition way of the frame glue and the disposition of the above-mentioned layers described in the present embodiment may be applied to the electronic devices of the embodiments and the variant embodiments of the present disclosure, and the structures of the reflective panels shown in FIG. 13 are exemplary.

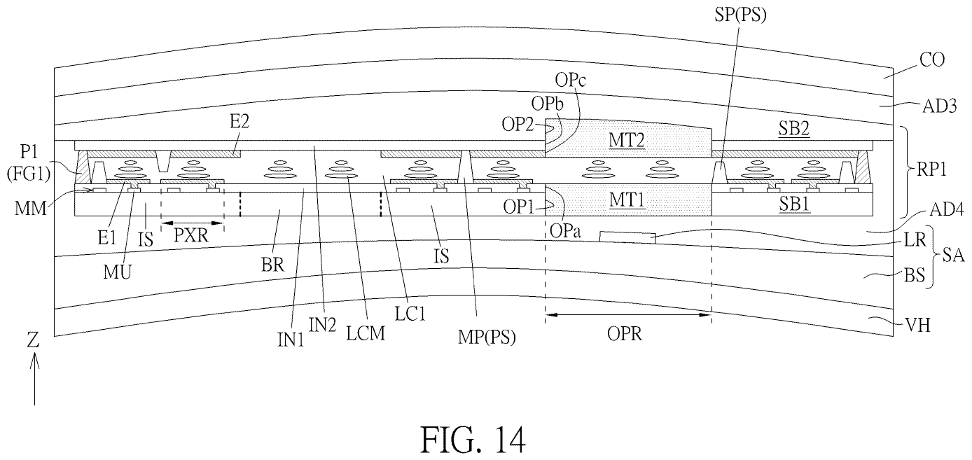

Referring to FIG. 14, FIG. 14 schematically illustrates a cross-sectional view of an electronic device according to a tenth embodiment of the present disclosure. In the present embodiment, the stretchable electronic device ED9 may include at least one reflective panel (for example, the first reflective panel RP1), but not limited thereto. The structure of the first reflective panel RP1 of the stretchable electronic device ED9 may for example refer to the structure of the first reflective panel RP1 shown in FIG. 2, but not limited thereto. It should be noted that although it is not shown in the figure, the protecting layers PL mentioned above may be optionally disposed at two sides of the first reflective panel RP1 respectively. In other embodiments, the reflective panel of the stretchable electronic device ED9 may be any reflective panel in the embodiments mentioned above. In some embodiments, the opening in the substrate of the reflective panel may not penetrate the substrate. As shown in FIG. 14, the second opening OP2 of the second substrate SB2 may not penetrate the second substrate SB2. The design of the opening of the substrate described herein may be applied to the electronic devices of the embodiments and the variant embodiments of the present disclosure.

The stretchable electronic device ED9 of the present embodiment may for example serve as a display for car or a display for other vehicles. FIG. 14 is a diagram showing the stretchable electronic device ED9 attached to a surface of a device element VH. The device element VH described herein may represent the shell, the window, the dashboard or other suitable elements in the vehicle. Since the stretchable electronic device ED9 can be stretched, it can be attached to any suitable surface of the device element VH. As shown in FIG. 14, the stretchable electronic device ED9 may be attached to the device element VH by a side adjacent to the first substrate SB1, but not limited thereto. In some embodiments, the stretchable electronic device ED9 may be attached to the device element VH by a side of the stretchable electronic device ED9 adjacent to the second substrate SB2.

According to the present embodiment, the stretchable electronic device ED9 may further include a solar cell SA, wherein the solar cell SA is disposed at a side of the first reflective panel RP1 away from the light emitting surface. For example, the solar cell SA may be disposed between the first reflective panel RP1 and the device element VH or disposed at a side of the stretchable electronic device ED9 attached to the device element VH, but not limited thereto. The solar cell SA may include a substrate BS and a light sensing unit LR disposed on the substrate BS. In some embodiments, the stretchable electronic device ED9 may further include an adhesive layer located between the substrate BS and the device element VH, wherein the adhesive layer (not shown) may be used to attach the stretchable electronic device ED9 to the device element VH. Although it is not shown in the figure, the substrate BS may include a base and a circuit layer (not shown) disposed on the base, wherein the circuit layer (not shown) may include wires or conductive elements electrically connected to the light sensing unit LR. The substrate may at least partially include a flexible material, such that the solar cell SA is flexible. The light sensing unit LR may receive light and generate electrical energy. The light sensing unit LR may include a photodiode, but not limited thereto. In the present embodiment, the light sensing unit LR may be disposed to correspond to or overlap the opening in the substrate of the reflective panel (such as the first opening OP1 of the first substrate SB1 and/or the second opening OP2 of the second substrate SB2), but not limited thereto. Therefore, the light receiving effect of the light sensing unit LR may be improved. The stretchable electronic device ED9 may further include an adhesive layer AD4 disposed between the solar cell SA and the first reflective panel RP1. The adhesive layer AD4 may be disposed on the substrate BS and cover the light sensing unit LR. The adhesive layer AD4 may be used to attach the solar cell SA to the first reflective panel RP1. The adhesive layer AD4 may be optionally disposed on or in contact with the left side and the right side of the first reflective panel RP1, or the first reflective panel RP1 may be embedded in the adhesive layer AD4, but not limited thereto.

In the present embodiment, the stretchable electronic device ED9 may further include a covering layer CO disposed on the first reflective panel RP1. The first reflective panel RP1 may be disposed between the covering layer CO and the solar cell SA. The stretchable electronic device ED9 may further include an adhesive layer AD3, and the covering layer CO may be attached to the second substrate SB2 through the adhesive layer AD3. The covering layer CO may provide protection to the first reflective panel RP1. The covering layer CO may for example include transparent rigid materials, such as glass, but not limited thereto. The material of the adhesive layer AD3 may refer to the materials of the adhesive layer AD1 and the adhesive layer AD2 mentioned above, and will not be redundantly described.

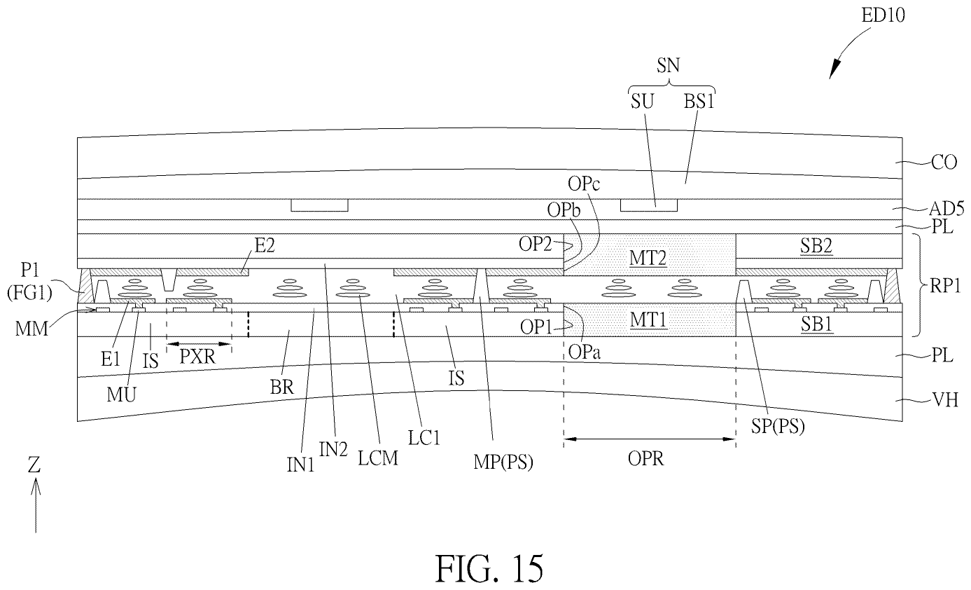

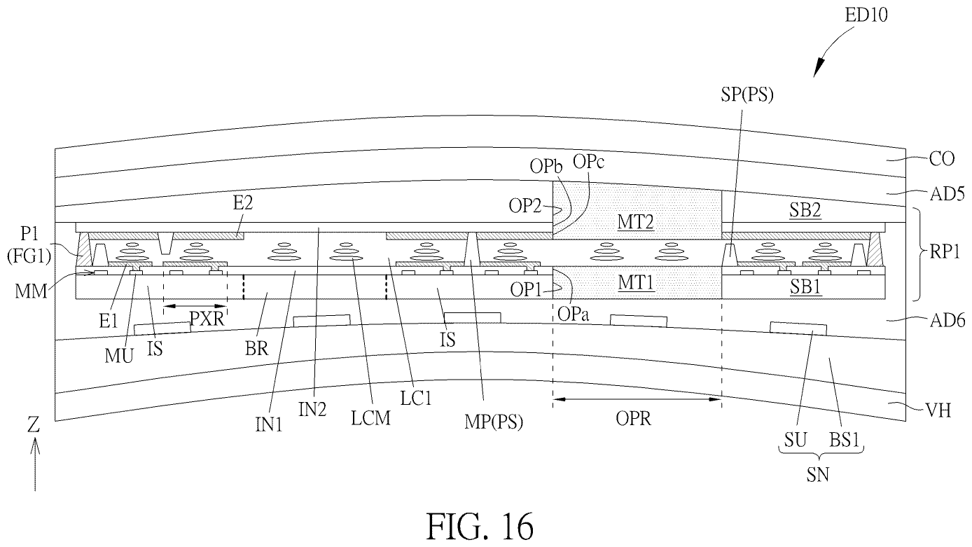

Referring to FIG. 15 and FIG. 16, FIG. 15 schematically illustrates a cross-sectional view of an electronic device according to an eleventh embodiment of the present disclosure, and FIG. 16 schematically illustrates a cross-sectional view of an electronic device according to a variant embodiment of the eleventh embodiment of the present disclosure. In the present embodiment, the stretchable electronic device ED10 may include a reflective panel (for example, the first reflective panel RP1), but not limited thereto. The structure of the first reflective panel RP1 of the stretchable electronic device ED10 may for example refer to the structure of the first reflective panel RP1 shown in FIG. 2, but not limited thereto. As shown in FIG. 15, the protecting layer PL below the first substrate SB1 may be located between the first reflective panel RP1 and the device element VH. Although it is not shown in the figure, the stretchable electronic device ED10 may include an adhesive layer (not shown) disposed between the protecting layer PL below the first substrate SB1 and the device element VH, and the adhesive layer may be used to attach the stretchable electronic device ED10 to the device element VH.

According to the present embodiment, the stretchable electronic device ED10 may further include a sensing element layer SN disposed at a side of the first reflective panel RP1 away from the device element VH. The sensing element layer SN may include a substrate BS1 and sensing units SU disposed on a surface of the substrate BS1 facing the first reflective panel RP1. That is, the sensing units SU may be located between the substrate BS1 and the first reflective panel RP1. Although it is not shown in the figure, the substrate BS1 may include a base (not shown) and a circuit layer (not shown) disposed on the base, wherein the circuit layer may include wires or conductive elements electrically connected to the sensing units SU. The base may at least partially include a flexible material, such that the sensing element layer SN is flexible. The sensing unit SU may include any suitable sensor, such as biosensor, fingerprint sensor, optical sensor, and the like, but not limited thereto. In the present embodiment, the sensing units SU may be disposed not corresponding to the island portions IS of the substrate of the reflective panel. As shown in FIG. 15, the sensing units SU may be disposed not corresponding to the island portions IS or the pixel regions PXR. The sensing units SU may for example overlap the bridge portions BR of the first substrate SB1 and the second substrate SB2, the first opening OP1 of the first substrate SB1 and/or the second opening OP2 of the second substrate SB2, but not limited thereto. Therefore, the influence of the sensing units SU on the display function of the stretchable electronic device ED10 may be reduced. The stretchable electronic device ED10 may further include an adhesive layer AD5 disposed between the sensing element layer SN and the protecting layer PL located on the second substrate SB2, wherein the adhesive layer AD5 may be used to attach the sensing element layer SN to the first reflective panel RP1. The stretchable electronic device ED10 may further include a covering layer CO disposed on the sensing element layer SN. The features of the covering layer CO may refer to the contents mentioned above, and will not be redundantly described. Although it is not shown in the figure, the stretchable electronic device ED10 may further include an adhesive layer, and the covering layer CO may be attached to the sensing element layer SN through the adhesive layer.

In some embodiments, as shown in FIG. 16, the sensing element layer SN may be disposed at a side of the first reflective panel RP1 facing the device element VH, that is, the sensing element layer SN may be disposed at a side of the stretchable electronic device ED10 used for attachment. In such condition, the sensing units SU may be disposed on a surface of the substrate BS1 facing the first reflective panel RP1. Specifically, the stretchable electronic device ED10 may include an adhesive layer AD6, and the sensing element layer SN may be attached to the first reflective panel RP1 through the adhesive layer AD6. In the present variant embodiment, since the sensing element layer SN is disposed between the first reflective panel RP1 and the device element VH, the sensing units SU may be disposed at any suitable position on the substrate BS1, which is not limited by the positions of the pixel regions PXR in the first reflective panel RP1. In the present variant embodiment, the protecting layer PL may be included or not included in the stretchable electronic device ED10, but not limited thereto.

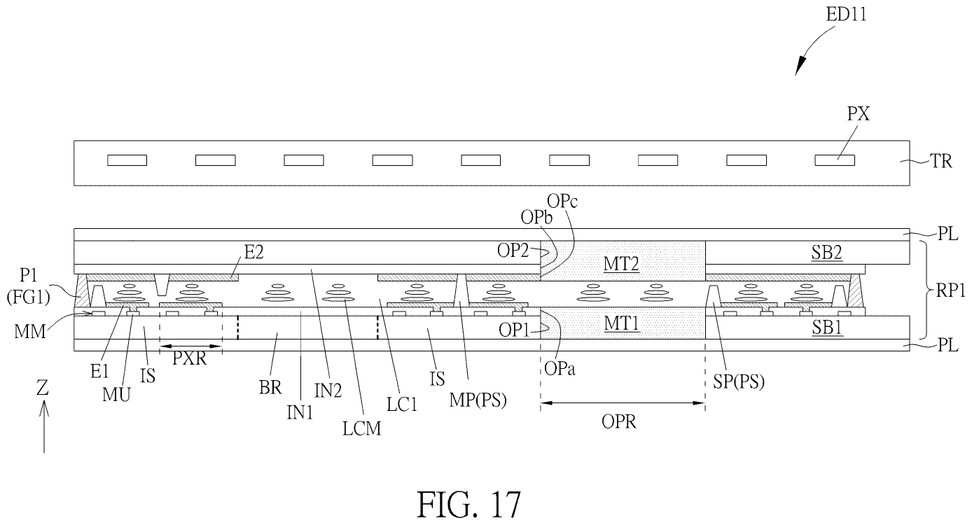

Referring to FIG. 17, FIG. 17 schematically illustrates a cross-sectional view of an electronic device according to a twelfth embodiment of the present disclosure. In the present embodiment, the stretchable electronic device ED11 may include a reflective panel (for example, the first reflective panel RP1), but not limited thereto. The structure of the first reflective panel RP1 of the stretchable electronic device ED11 may for example refer to the structure of the first reflective panel RP1 shown in FIG. 2, but not limited thereto. According to the present embodiment, the stretchable electronic device ED11 further includes a transparent display device TR disposed on the first reflective panel RP1. The transparent display device TR may include a plurality of display pixels PX for displaying images or pictures. The structure of the transparent display device TR shown in FIG. 17 is exemplary, and the transparent display device TR may further include other elements or layers. The stretchable electronic device ED11 of the present embodiment may serve as a display for car or a display for other vehicles, but not limited thereto. In such condition, the transparent display device TR may be used as the main display device to display any suitable information; and the first reflective panel RP1 may be used as a decorating layer to display a background pattern or a pure color image to increase contrast of images. By disposing the first reflective panel RP1 below the transparent display device TR, the transparent display device TR may be attached to any suitable surface through the first reflective panel RP1, thereby increasing the application of the transparent display device TR.

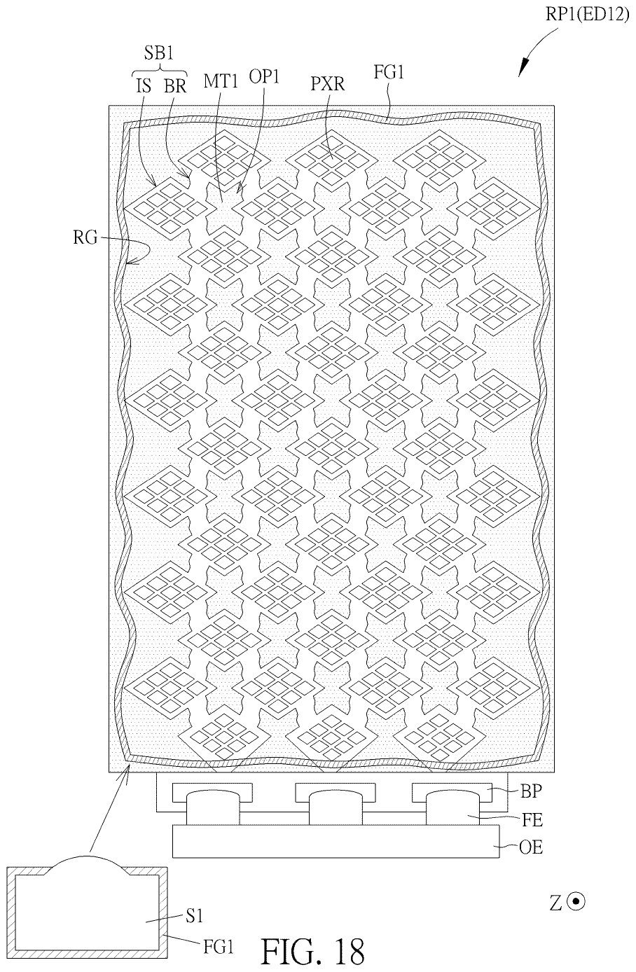

Referring to FIG. 18, FIG. 18 schematically illustrates a top view of an electronic device according to a thirteenth embodiment of the present disclosure. One of the main differences between the stretchable electronic device ED12 of the present embodiment and the stretchable electronic device ED shown in FIG. 1 is the disposition way of the frame glue. FIG. 18 for example shows a top view structure of a reflective panel (for example, the first reflective panel RP1) in the stretchable electronic device ED12, and the stretchable electronic device ED12 may include one or more reflective panels. Specifically, as shown in FIG. 18, in the top view direction of the stretchable electronic device ED12, the first frame glue FG1 in the first reflective panel RP1 may be disposed along the outer edge of the first reflective panel RP1 and have a wave shape or other suitable curve shapes. Therefore, the flexibility of the edge of the first reflective panel RP1 may be improved. The above-mentioned first frame glue FG1 having a wave shape may be applied to other embodiments or variant embodiments. When the first frame glue FG1 is disposed in the way shown in FIG. 3, the first frame glue FG1 may have a wave shape extending along the outer edge of the first substrate SB1 in the top view direction of the stretchable electronic device ED1; and when the first frame glue FG1 is disposed in the way shown in FIG. 5, the first frame glue FG1 may have a wave shape extending along the outer edge of the island portion IS of the first substrate SB1 in the top view direction of the stretchable electronic device ED2. Therefore, the situation that the first liquid crystal layer LC1 pierces the first frame glue FG1 when the stretchable electronic device is stretched may be reduced. In addition, in the present embodiment, the first frame glue FG1 may be disposed on a flat surface or a surface similar to a flat surface. For example, as shown in FIG. 18, when the first frame glue FG1 is disposed on a surface S1, the first frame glue FG1 may be disposed in a relatively flat region (or a region with a lower absolute value of Gaussian curvature) of the surface S1. According to FIG. 2 and related contents mentioned above, the surface S1 described herein may for example include the surface of the insulating layer IN1 and/or the surface of the first material layer MT1, but not limited thereto.

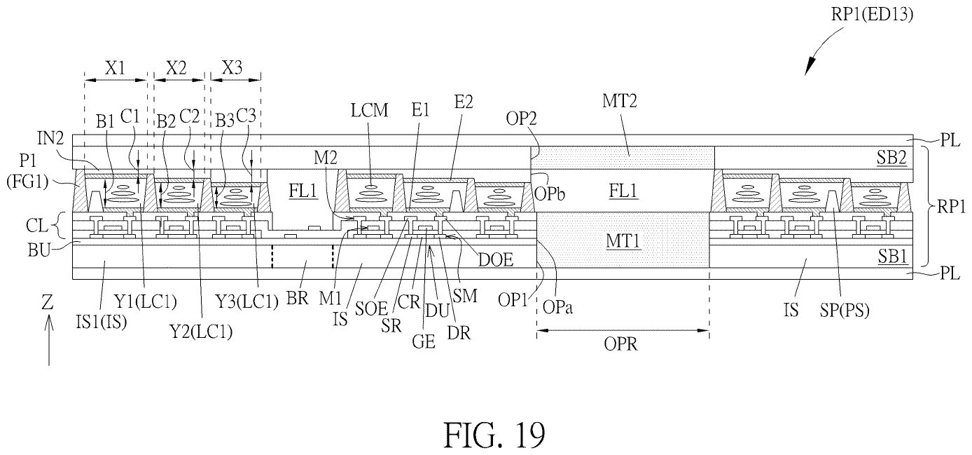

Referring to FIG. 19, FIG. 19 schematically illustrates a cross-sectional view of an electronic device according to a fourteenth embodiment of the present disclosure. The stretchable electronic device ED13 of the present embodiment may include a reflective panel, such as the first reflective panel RP1, but not limited thereto. The first reflective panel RP1 may for example be driven in an active driving way, and the structure thereof may refer to the structures shown in FIG. 8 to FIG. 11 and related contents mentioned above, but not limited thereto. According to the present embodiment, the first liquid crystal layer LC1 in the first reflective panel RP1 may reflect lights of different colors. For example, in the present embodiment, a portion of the first frame glue FG1 in the first reflective panel RP1 corresponding to an island portion IS may further enclose three regions corresponding to the island portion IS in addition to being disposed along the outer edge of the island portion IS (refer to FIG. 5), and the portions of the first liquid crystal layer LC1 respectively be disposed in the three regions may respectively reflect lights of different colors in a reflective state. As shown in FIG. 19, taking the island portion IS1 as an example, the first frame glue FG1 may enclose three regions (that is, the region X1, the region X2 and the region X3) corresponding to the island portion IS1 in addition to being disposed along the outer edge of the island portion IS1 of the first substrate SB1. The region X1, the region X2 and the region X3 may be separated from each other by the first frame glue FG1. That is, the region X1, the region X2 and the region X3 may not contact each other. The sizes of the region X1, the region X2 and the region X3 may be determined according to the demands of design (for example, the demand of size of pixels of different colors) of the first reflective panel RP1. Different portions of the first liquid crystal layer LC1 may be disposed corresponding to the region X1, the region X2 and the region X3. The first liquid crystal layer LC1 may include a portion Y1, a portion Y2 and a portion Y3, wherein the portion Y1, the portion Y2 and the portion Y3 may be disposed to respectively correspond to or overlap the region X1, the region X2 and the region X3. According to the present embodiment, the thicknesses of the portion Y1, the portion Y2 and the portion Y3 of the first liquid crystal layer LC1 may be different from each other. As shown in FIG. 19, the portion Y1 of the first liquid crystal layer LC1 may have a thickness B1, the portion Y2 of the first liquid crystal layer LC1 may have a thickness B2, and the portion Y3 of the first liquid crystal layer LC1 may have a thickness B3, wherein the thickness B1, the thickness B2 and the thickness B3 may be different from each other. Through the above-mentioned design, the portion Y1, the portion Y2 and the portion Y3 of the first liquid crystal layer LC1 may respectively reflect lights of different colors. In the present embodiment, the portion Y1, the portion Y2 and the portion Y3 of the first liquid crystal layer LC1 may respectively reflect red light, green light and blue light in a reflective state through the designs of the thickness B1, the thickness B2 and the thickness B3, but not limited thereto. Through the above-mentioned structural design, since different portions of the first liquid crystal layer LC1 in different regions of the first reflective panel RP1 may reflect lights of various colors, the stretchable electronic device ED13 may display color images while reducing the number of reflective panels or reducing the thickness of the stretchable electronic device ED13. In other embodiments, the first frame glue FG1 corresponding to an island portion IS may enclose any number of regions, and different portions of the first liquid crystal layer LC1 disposed corresponding to these regions may have different thicknesses.

In the present embodiment, the thickness B1, the thickness B2 and the thickness B3 may be different from each other through the thickness design of the insulating layer IN2, but not limited thereto. As shown in FIG. 19, the portions of the insulating layer IN2 respectively corresponding to the region X1, the region X2 and the region X3 may respectively have a thickness C1, a thickness C2 and a thickness C3, wherein the thickness C1, the thickness C2 and the thickness C3 may be different from each other, such that the thickness B1, the thickness B2 and the thickness B3 are different from each other. In the present embodiment, the insulating layer IN2 may have a stepped structure such that the thickness C1 is lower than the thickness C2, and the thickness C2 is lower than the thickness C3, but not limited thereto. In such condition, since the sum of the thickness B1 and the thickness C1, the sum of the thickness B2 and the thickness C2, and the sum of the thickness B3 and the thickness C3 may be substantially the same, the thickness B1 may be lower than the thickness B2, and the thickness B2 may be lower than the thickness B3. In other embodiments, the thickness B1, the thickness B2 and the thickness B3 may be different from each other through the thickness design of other layers in the first reflective panel RP1. For example, the thickness B1, the thickness B2 and the thickness B3 may be different from each other through the thickness design of at least one insulating layer in the circuit layer CL.

It should be noted that the disposition ways and/or the thickness designs of the first frame glue FG1, the first liquid crystal layer LC1 and the insulating layer IN2 corresponding to other island portions IS may refer to the contents mentioned above, and will not be redundantly described.

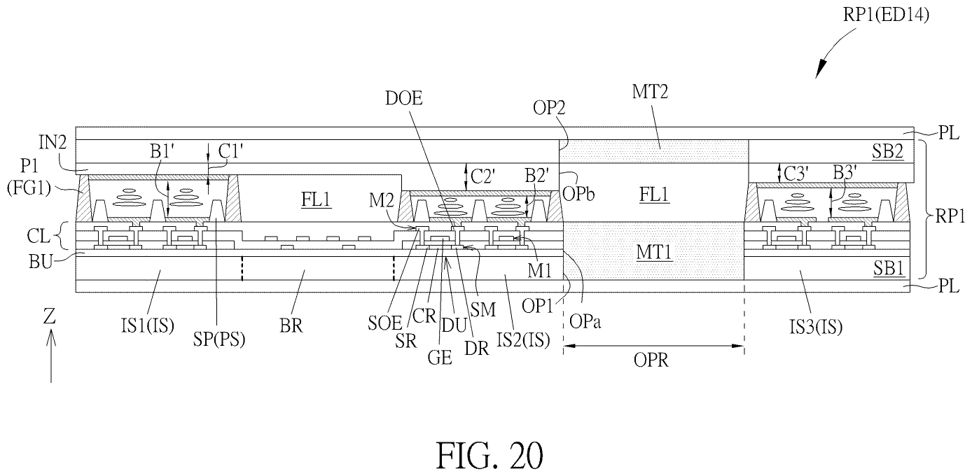

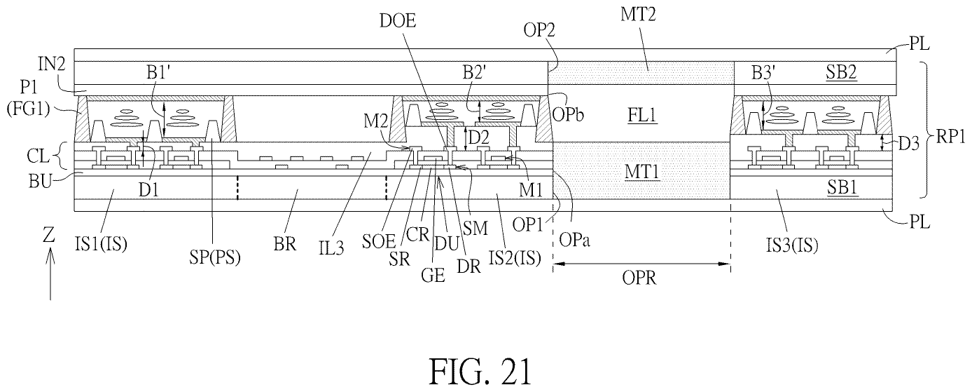

Referring to FIG. 20 and FIG. 21, FIG. 20 schematically illustrates a cross-sectional view of an electronic device according to a fifteenth embodiment of the present disclosure, and FIG. 21 schematically illustrates a cross-sectional view of an electronic device according to a variant embodiment of the fifteenth embodiment of the present disclosure. The stretchable electronic device ED14 of the present embodiment may include a reflective panel, such as the first reflective panel RP1, but not limited thereto. The first reflective panel RP1 may for example be driven in an active driving way, and the structure thereof may refer to the structures shown in FIG. 8 to FIG. 11 and related contents mentioned above, but not limited thereto. In the present embodiment, the first frame glue FG1 in the first reflective panel RP1 may be disposed along the outer edges of the island portions IS of the first substrate SB1, and the details thereof may refer to FIG. 5 and the contents mentioned above, which will not be redundantly described. In the first reflective panel RP1, the portions of the first liquid crystal layer LC1 corresponding to different island portions IS may respectively reflect lights of different colors in a reflective state. As shown in FIG. 20, a portion of the first liquid crystal layer LC1 corresponding to the island portion IS1 may have a thickness B1′, a portion of the first liquid crystal layer LC1 corresponding to the island portion IS2 may have a thickness B2′, and a portion of the first liquid crystal layer LC1 corresponding to the island portion IS3 may have a thickness B3′, wherein the thickness B1′, the thickness B2′ and the thickness B3′ may be different from each other. Through the design mentioned above, different portions of the first liquid crystal layer LC1 respectively corresponding to the island portion IS1, the island portion IS2 and the island portion IS3 may respectively reflect lights of different colors in a reflective state. In the present embodiment, the portions of the first liquid crystal layer LC1 respectively corresponding to the island portion IS1, the island portion IS2 and the island portion IS3 may respectively reflect red light, green light and blue light through the designs of the thickness B1′, the thickness B2′ and the thickness B3′, but not limited thereto. It should be noted that through the above-mentioned structural design, the first liquid crystal layer LC1 in the first reflective panel RP1 may reflect lights of any color, which is not limited to the situation mentioned above.

As shown in FIG. 20, the thickness B1′, the thickness B2′ and the thickness B3′ may be different from each other through the thickness design of the insulating layer IN2. As shown in FIG. 20, the portions of the insulating layer IN2 respectively corresponding to the island portion IS1, the island portion IS2 and the island portion IS3 may respectively have a thickness C1′, a thickness C2′ and a thickness C3′, and the thickness C1′, the thickness C2′ and the thickness C3′ may be different from each other, such that the thickness B1′, the thickness B2′ and the thickness B3′ may be different from each other. In some embodiments, the thickness B1′, the thickness B2′ and the thickness B3′ may be different from each other through the thickness design of the layer in the circuit layer CL. As shown in FIG. 21, the portions of the insulating layer IL3 in the circuit layer CL respectively corresponding to the island portion IS1, the island portion IS2 and the island portion IS3 may respectively have a thickness D1, a thickness D2 and a thickness D3, and the thickness D1, the thickness D2 and the thickness D3 may be different from each other, such that the thickness B1′, the thickness B2′ and the thickness B3′ may be different from each other. In other embodiments, the thickness B1′, the thickness B2′ and the thickness B3′ may be different from each other through the thickness design of other insulating layers in the circuit layer CL, which is not limited to the situation mentioned above.

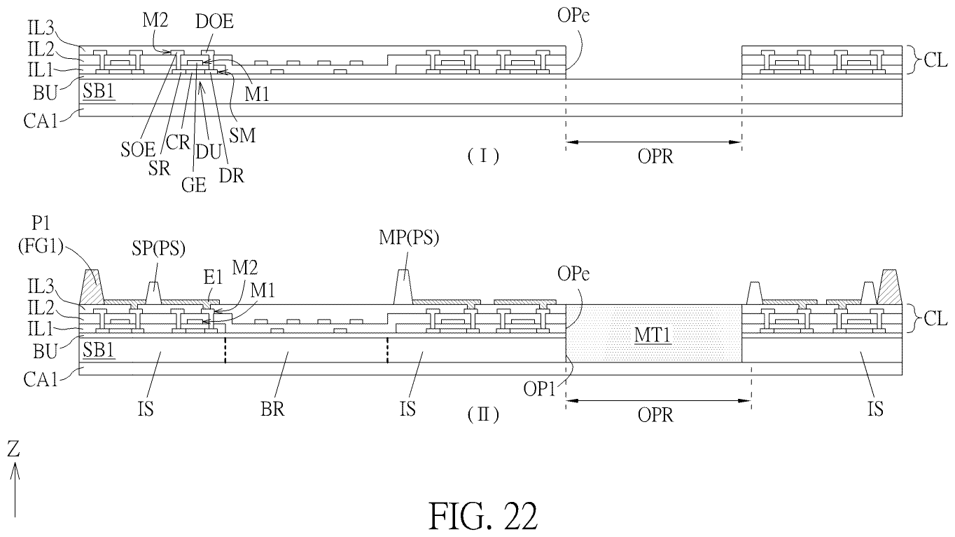

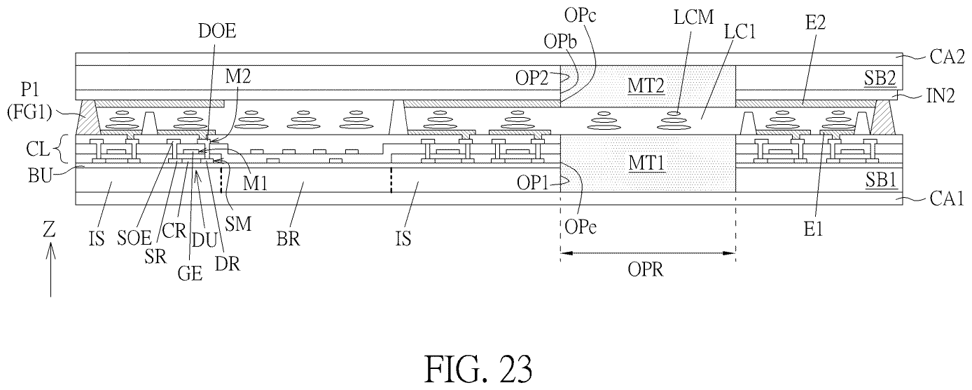

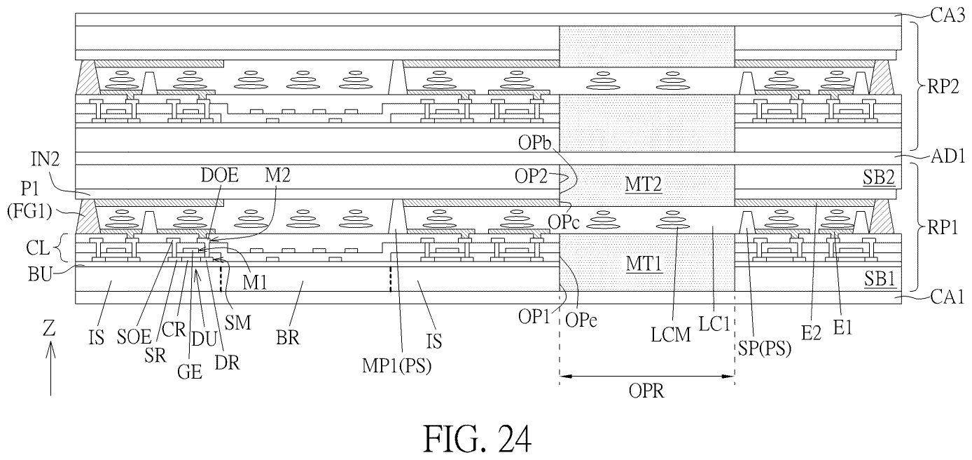

Referring to FIG. 22 to FIG. 24, FIG. 22 and FIG. 23 schematically illustrate a manufacturing process of a reflective panel according to an embodiment of the present disclosure, and FIG. 24 schematically illustrates a manufacturing process of an electronic device according to an embodiment of the present disclosure. FIG. 22 to FIG. 23 show the manufacturing process of a reflective panel driven in an active driving way. The first reflective panel RP1 is taken as an example to describe the manufacturing process of the reflective panel in FIG. 22 to FIG. 23, and the second reflective panel RP2 and the third reflective panel RP3 may be formed through the same way, which will not be redundantly described. According to the present embodiment, the manufacturing process of the first reflective panel RP1 may include providing the first substrate SB1 and forming the circuit layer CL on the first substrate SB1 at first. Specifically, as shown in the structure (I) of FIG. 22, a carrier CA1 may be provided at first, and the first substrate SB1 may be disposed on the carrier CA1. After that, the circuit layer CL may be formed on the first substrate SB1. For example, the insulating layer IL1, the insulating layer IL2 and the insulating layer IL3 may be disposed on the first substrate SB1, and the above-mentioned insulating layers may be patterned through any suitable patterning process (for example, a lithography process or an etching process, but not limited thereto) to define the patterns of the conductive elements (for example, the conductive layer M1 and the conductive layer M2) in the circuit layer CL. The patterning process mentioned above may further include removing portions of the insulating layer IL1, the insulating layer IL2 and the insulating layer IL3 to form an opening, that is, the opening OPe, wherein the opening OPe may correspond to or overlap the opening region OPR or correspond to the first opening OP1 formed subsequently. It should be noted that although it is not shown in the figure, when the first reflective panel RP1 is driven in a passive driving way, the manufacturing process of the circuit layer CL may for example be replaced by the manufacturing processes of the conductive layer MM and the insulating layer IN1. For example, the conductive layer MM may be formed on the first substrate SB1 at first, and then the insulating layer IN1 may be disposed on the conductive layer MM, but not limited thereto.

As shown in the structure (II) of FIG. 22, after the circuit layer CL is formed, a patterning process may be performed on the first substrate SB1 to form the plurality of island portions IS, the plurality of bridge portions BR and at least one first opening OP1, wherein the first opening OP1 may correspond to the opening OPe of the circuit layer CL. After that, the first material layer MT1 may be disposed in the first opening OP1. Specifically, the first material layer MT1 may be filled in the first opening OP1 and/or the opening OPe of the circuit layer CL. In some embodiments, the first opening OP1 may penetrate the first substrate SB1, and the first material layer MT1 may contact the carrier CA1. In some embodiments, the first opening OP1 may not penetrate the first substrate SB1, and the first material layer MT1 may not contact the carrier CA1. The manufacturing process of the first refractive panel RP1 may further include disposing the first electrodes E1, the spacers PS and the first frame glue FG1 on the circuit layer CL, but not limited thereto. The first electrodes E1, the spacers PS and the first frame glue FG1 may respectively be disposed through the ways described in the above-mentioned embodiments and variant embodiments, which are not limited to the structure shown in FIG. 22. It should be noted that the first material layer MT1, the first electrodes E1, the spacers PS and the first frame glue FG1 may be disposed in any suitable order.

As shown in FIG. 23, after the first frame glue FG1 is disposed, the first liquid crystal layer LC1 may be disposed in a range (that is, the range RG mentioned above) enclosed by the first frame glue FG1. In some embodiments, the first frame glue FG1 and the first liquid crystal layer LC1 may be disposed on the second substrate SB2. The manufacturing process of the first reflective panel RP1 may further include providing the second substrate SB2 and forming the insulating layer IN2 and the second electrodes E2 on the second substrate SB2. Specifically, a carrier CA2 may be provided at first, and then the second substrate SB2 may be disposed on the carrier CA2. After that, the insulating layer IN2 may be formed on the second substrate SB2, and the second electrodes E2 may be formed on the insulating layer IN2. The manufacturing process of the first reflective panel RP1 may further include performing a patterning process on the second substrate SB2, the insulating layer IN2 and/or the second electrodes E2. In such condition, the second substrate SB2 may be patterned to form the plurality of island portions IS, the plurality of bridge portions BR and at least one second opening OP2; the insulating layer IN2 may be patterned to form the opening OPb corresponding to the second opening OP2; and the second electrodes E2 may include the opening OPc corresponding to the second opening OP2. In some embodiments, the second substrate SB2 and the insulating layer IN2 may not be patterned. After the patterning process mentioned above, the manufacturing process of the first reflective panel RP1 may further include disposing the second material layer MT2. Specifically, the second material layer MT2 may be filled in the second opening OP2, the opening OPb and/or the opening OPc. Although it is not shown in the figure, the manufacturing process of the first reflective panel RP1 may further include disposing the spacers PS on the insulating layer IN2. After the above-mentioned processes are completed, the first substrate SB1 and the second substrate SB2 may be combined to form the first reflective panel RP1. In some embodiments, after the first substrate SB1 and the second substrate SB2 are combined, the carrier CA1 and the carrier CA2 located at two sides of the first reflective panel RP1 may be optionally removed, and the protecting layers (that is, the protecting layers PL mentioned above) may be disposed at two sides of the first reflective panel RP1. The coefficient of elasticity of the material of the protecting layers PL may be greater than the coefficient of elasticity of the carrier CA1 and the carrier CA2.

In some embodiments, the stretchable electronic device may include a reflective panel, such as the first reflective panel RP1. That is, the manufacturing process of the first reflective panel RP1 mentioned above may be the manufacturing process of the stretchable electronic device. In some embodiments, the stretchable electronic device may include multiple reflective panels. In such condition, the stretchable electronic device may be formed by stacking the plurality of reflective panels formed through the above-mentioned process. In some embodiments, the plurality of reflective panels may be adhered to each other to form the stretchable electronic device. As shown in FIG. 24, after the first reflective panel RP1 and another reflective panel (for example, the second reflective panel RP2) are formed through the above-mentioned process, the carrier (for example, the carrier CA2 shown in FIG. 23) at the side of the first reflective panel RP1 used for adhering may be removed, and the carrier at the side of the second reflective panel RP2 used for adhering may be removed. After that, the first reflective panel RP1 and the second reflective panel RP2 may be adhered to each other through an adhesive layer AD1 to form the stretchable electronic device. In some embodiments, after the first reflective panel RP1 and the second reflective panel RP2 are adhered to each other, the outermost carrier CA1 and/or carrier CA3 may be removed, and the protecting layer PL may be optionally disposed at the outermost side of the first reflective panel RP1 or the second reflective panel RP2. When the stretchable electronic device includes three or more than three reflective panels, these reflective panels may be adhered to each other through the same way, and the details thereof will not be redundantly described. In some embodiments, although it is not shown in the figure, the second reflective panel RP2 may be directly disposed on the first reflective panel RP1. For example, after the first reflective panel RP1 is formed, the carrier CA2 may be removed, and the elements such as the circuit layer CL may be formed on the second substrate SB2 of the first reflective panel RP1 to form the second reflective panel RP2. In such condition, the second substrate SB2 of the first reflective panel RP1 may serve as the lower substrate of the second reflective panel RP2 (that is, the third substrate SB3 mentioned above), but not limited thereto. In some embodiments, the third substrate SB3 may be formed on the second substrate SB2, and the elements such as the circuit layer CL may be formed on the third substrate SB3 to form the second reflective panel RP2.

In summary, an electronic device composed of at least one reflective panel is provided by the present disclosure. The reflective panel includes two substrates opposite to each other, wherein at least one of the two substrates may be patterned to include at least one opening. Through the above-mentioned structural design, the electronic device of the present disclosure may be stretched and may be attached to any suitable surface, thereby increasing the application of the electronic device. In addition, through the position design of the frame glue in the reflective panel, the change in the thickness of the liquid crystal layer may be reduced when the electronic device is stretched, thereby improving the display performance of the reflective panel.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A stretchable electronic device, comprising:
a first reflective panel, comprising:
a first substrate having at least one first opening;
a second substrate opposite to the first substrate;
a first liquid crystal layer disposed between the first substrate and the second substrate;
a first frame glue disposed between the first substrate and the second substrate and adjacent to the first liquid crystal layer; and
a first material layer disposed in the at least one first opening, wherein a material of the first material layer is different from a material of the first substrate.

2. The stretchable electronic device of claim 1, wherein the first reflective panel has a plurality of pixel regions, and the at least one first opening is not overlapped with the plurality of pixel regions in a top view direction of the stretchable electronic device.

3. The stretchable electronic device of claim 2, wherein the first reflective panel comprises a plurality of first electrodes and a plurality of second electrodes, the first liquid crystal layer is disposed between the plurality of first electrodes and the plurality of second electrodes, and a plurality of overlapping regions of the plurality of first electrodes overlapping the plurality of second electrodes define the plurality of pixel regions.

4. The stretchable electronic device of claim 1, wherein the first frame glue surrounds the first liquid crystal layer, and the first liquid crystal layer overlaps the at least one first opening in a top view direction of the stretchable electronic device.

5. The stretchable electronic device of claim 1, wherein the first frame glue surrounds the first liquid crystal layer, and the first liquid crystal layer does not overlap the at least one first opening in a top view direction of the stretchable electronic device.

6. The stretchable electronic device of claim 1, wherein the first frame glue comprises a plurality of annular portions, the first liquid crystal layer comprises a plurality of sub liquid crystal layer portions, the plurality of annular portions of the first frame glue respectively surround the plurality of sub liquid crystal layer portions of the first liquid crystal layer, and the plurality of sub liquid crystal layer portions are not connected to each other.

7. The stretchable electronic device of claim 6, wherein the first reflective panel further comprises a filling layer disposed between the plurality of annular portions of the first frame glue, and the filling layer comprises a transparent material layer or an air layer.

8. The stretchable electronic device of claim 1, wherein a coefficient of elasticity of the first material layer is greater than a coefficient of elasticity of the first substrate.

9. The stretchable electronic device of claim 1, wherein the first reflective panel further comprises a protecting layer disposed at a side of the first substrate away from the first liquid crystal layer, and a coefficient of elasticity of the protecting layer is greater than a coefficient of elasticity of the first substrate.

10. The stretchable electronic device of claim 9, wherein the protecting layer overlaps the at least one first opening in a top view direction of the stretchable electronic device.

11. The stretchable electronic device of claim 1, wherein the second substrate has at least one second opening, and the at least one second opening corresponds to the at least one first opening.

12. The stretchable electronic device of claim 1, wherein the first frame glue comprises a photo-curable adhesive or a thermosetting adhesive.

13. The stretchable electronic device of claim 1, wherein the first substrate comprises a plurality of island portions and a plurality of bridge portions, and at least one of the plurality of bridge portions connects adjacent two of the plurality of island portions.

14. The stretchable electronic device of claim 13, wherein the first reflective panel comprises a plurality of first electrodes and a plurality of second electrodes, and the plurality of first electrodes and the plurality of second electrodes are disposed corresponding to the plurality of island portions.

15. The stretchable electronic device of claim 13, wherein the first reflective panel comprises a plurality of spacers disposed between the first substrate and the second substrate and disposed corresponding to the plurality of island portions.

16. The stretchable electronic device of claim 1, further comprising:
a second reflective panel disposed at a side of the first reflective panel, wherein the second reflective panel comprises:
a third substrate having at least one second opening;
a fourth substrate opposite to the third substrate;
a second liquid crystal layer disposed between the third substrate and the fourth substrate;
a second frame glue disposed between the third substrate and the fourth substrate and adjacent to the second liquid crystal layer; and
a second material layer disposed in the at least one second opening, wherein a material of the second material layer is different from a material of the third substrate; and
an adhesive layer disposed between the first reflective panel and the second reflective panel and used to fix the first reflective panel and the second reflective panel.

17. The stretchable electronic device of claim 16, wherein the at least one second opening corresponds to the at least one first opening.

18. The stretchable electronic device of claim 16, further comprising:
a third reflective panel disposed at a side of the second reflective panel opposite to the first reflective panel, wherein the third reflective panel comprises:
a fifth substrate having at least one third opening;
a sixth substrate opposite to the fifth substrate;
a third liquid crystal layer disposed between the fifth substrate and the sixth substrate;
a third frame glue disposed between the fifth substrate and the sixth substrate and adjacent to the third liquid crystal layer; and
a third material layer disposed in the at least one third opening, wherein a material of the third material layer is different from a material of the fifth substrate; and
another adhesive layer disposed between the second reflective panel and the third reflective panel and used to fix the second reflective panel and the third reflective panel.

19. The stretchable electronic device of claim 18, wherein the first liquid crystal layer reflects lights of a first color, the second liquid crystal layer reflects lights of a second color, the third liquid crystal layer reflects lights of a third color, and the first color, the second color, and the third color are different colors.

20. The stretchable electronic device of claim 19, wherein the first color, the second color and the third color are respectively red, green and blue.
